(19) United States
(12) Patent Application Publication
(10) Pub. No.: US 2011/0103222 A1
(43) Pub. Date: May 5, 2011

(54) SIGNAL TRANSMISSION METHOD AND TRANSMISSION DEVICE

(75) Inventors: Ryoichi MUTOH, Kawasaki (JP); Yasuki Fujii, Kawasaki (JP); Toru Katagiri, Kawasaki (JP)

(73) Assignee: FUJITSU LIMITED, Kawasaki-shi (JP)

(21) Appl. No.: 12/913,061

(22) Filed: Oct. 27, 2010

(30) Foreign Application Priority Data
Oct. 29, 2009 (JP) 2009-248570

(51) Int. Cl. G06F 11/00

(52) U.S. Cl. 370/228

(57) ABSTRACT

A signal transmission method includes causing each of a plurality of nodes to transfer, using the actually used line, a second signal in a second layer, in which one or a plurality of first signals in a first layer are contained, to a node adjacent in the first or the second direction when each of the plurality of nodes transmits or receives the first signal, when no failure occurs in a transmission path in a network, and causing a first node, located at an end of a failure point, to switch a transmission direction of the second signal and to send out the second signal to the backup line, and causing a second node, which is a transmission source or a reception destination of the first signal, to select one of the first and second directions, when a failure occurs in the transmission path in the network.

### CROSS-REFERENCE TO RELATED APPLICATIONS

This application is based upon and claims the benefit of priority of the prior Japanese Patent Application No. 2009-248570, filed on Oct. 29, 2009, the entire contents of which are incorporated herein by reference.

### FIELD

The embodiment(s) discussed herein are related to a signal transmission method and transmission device.

### BACKGROUND

A communication standard for a next-generation optical transport network (OTN) has been studied per ITU-T (International Telecommunications Union-Telecommunication Standardization Sector) recommendation G.709. In this communication standard, a hierarchical structure (three layers: optical channel payload unit (OPU), optical channel data unit (ODU), and optical channel transport unit (OTU)) that is the same as synchronous optical network (SONET)/synchronous digital hierarchy (SDH) is defined.

An OTN frame format defined in the ITU-T recommendation G.709 is illustrated in FIG. 1. For example, as illustrated in FIG. 1, an OTN frame includes an ODU overhead (OH) that has four rows*fourteen columns (bytes) and an OPU overhead (OH) that follows the ODU OH and has four rows*two columns. A control signal used for operation and maintenance is mapped to each of the overheads. Furthermore, the OTN frame includes an OPUk payload and OTU forward error correction (OTUFEC), which follow the OPU OH.

FIG. 2 illustrates the formats of a PM field and a TCM field in the OTN frame. As illustrated in FIG. 2, a trail trace identifier (TTI) field includes a source access point identifier (SAPI), a destination access point identifier (DAPI), and operator specific information (operator specific). The access point identifier has a globally unique value for a layer to be an object. Individual pieces of information such as backward error indication/backward incoming alignment error (BEI/BIAE), backward detection indication (BDI), and status (STAT) are mapped to each of the third bytes of the path monitoring (PM) field and tandem connection monitoring (TCM) i fields (i=1 to 6). The STAT indicates information relating to an alarm in the ODUk layer.

In addition, in ITU-T recommendation G.709, an ODU concept has two layers, higher order/lower order-optical data units (HO/LO-ODUs), in order to easily realize containing of a client signal that has an arbitrary bit rate. As illustrated in FIGS. 3A and 3B, in this concept, various types of client signals (Client Layer Signals) such as signals complying with a synchronous transport module (STM)-16, an asynchronous transfer mode (ATM), a generic frame procedure (GFP), or the like are contained (mapped) in the LO-ODU (FIG. 3A). In addition, one or a plurality of LO-ODUs are multiply contained (mapped) in the HO-ODU (FIG. 3B).

By the way, a protection technique for the OTN is specified as ITU-T recommendation G.873.1 (ODUk linear protection). An example of the ODUk linear protection is illustrated in FIG. 4.

In the protection illustrated in FIG. 4, a domain (protected domain) to which the protection is applied is defined (a domain between a node N2 and a node N5 in the example illustrated in FIG. 4). In FIG. 4, the node N2 is a transmitting node, and the node N5 is a receiving node. Here, nodes N2→N1→N6→N5 are set to a working entity that functions as an actually used line. In addition, nodes N2→N3→N4→N5 are set to a protection entity that functions as a backup line. The node N2 that is a transmitting side executes a bridge function (a processing operation in which a signal to be transmitted is copied from the actually used line to the backup line). The node N5 that is a receiving side functions as a selector (a processing operation in which a high-quality signal is selected from one of the actually used line and the backup line). Here, for example, if a failure occurs in a transmission path between the node N5 and the node N6, the quality of a signal that the node N5 receives from the actually used line decreases. Therefore, the node N5 selects a signal received from the backup line.

In addition, a protection technique for SONET/SDH is defined as ITU-T recommendation G.841. In addition, for example, techniques relating to a protection technique for SONET/SDH are disclosed in Japanese Unexamined Patent Application Publication Nos. 2002-217927 and 2001-339416.

### SUMMARY

According to an aspect of the embodiment, a signal transmission method for transmitting a signal in a network wherein a plurality of nodes are connected in a ring shape, the signal is capable of being transmitted from individual nodes in first and second directions toward adjacent nodes, and an actually used line and a backup line are provided in each of the transmission directions, the signal transmission method includes in a case in which no failure occurs in a transmission path in the network, causing each of the plurality of nodes to transfer, using the actually used line, a second signal in a second layer, in which one or a plurality of first signals in a first layer are contained, to a node adjacent in the first or the second direction when each of the plurality of nodes transmits or receives the first signal; and in a case in which a failure occurs in the transmission path in the network, causing a first node, located at an end of a failure point, to switch a transmission direction of the second signal and to send out the second signal to the backup line, and causing a second node, which is a transmission source or a reception destination of the first signal, to select one of the first and second directions as a transmission direction or a reception direction of the first signal so that a path for the first signal circumvents the failure point.

The object and advantages of the embodiment will be realized and attained by at least the elements, features, and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a diagram illustrating an OTN frame format;

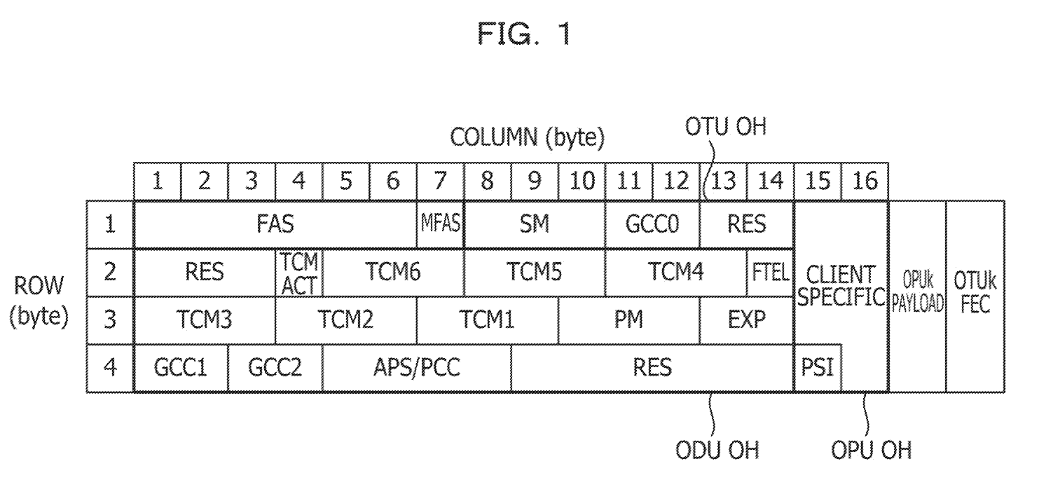

FIG. 2 is a diagram illustrating a PM/TCM format;

FIGS. 3A, 3B and 3C are diagrams illustrating a two layered ODU concept of HO/LO-ODU;

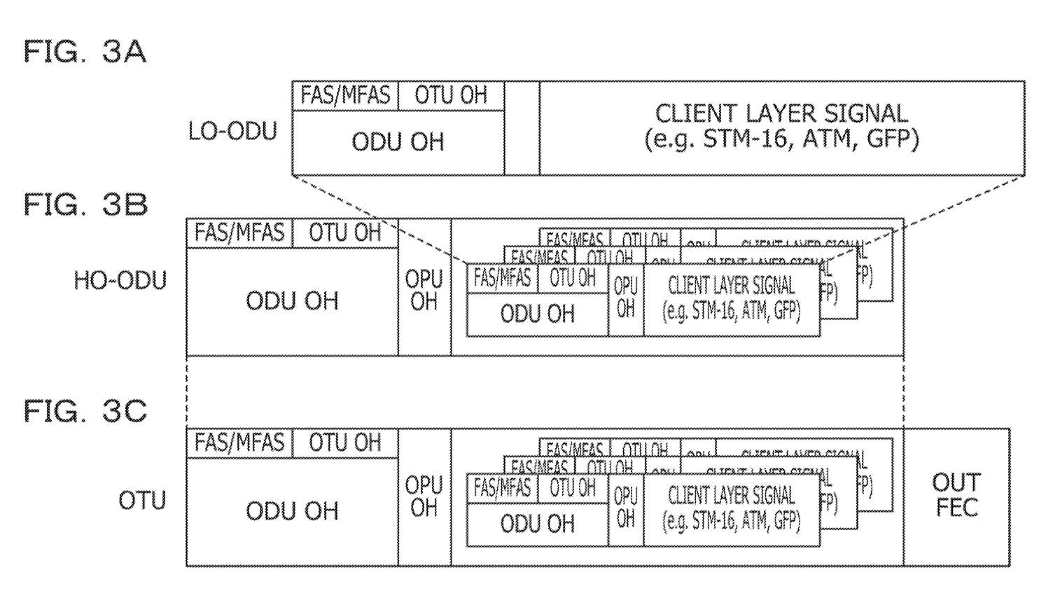

FIG. 4 is a diagram illustrating a linear protection function as an example of a protection technique of the related art;

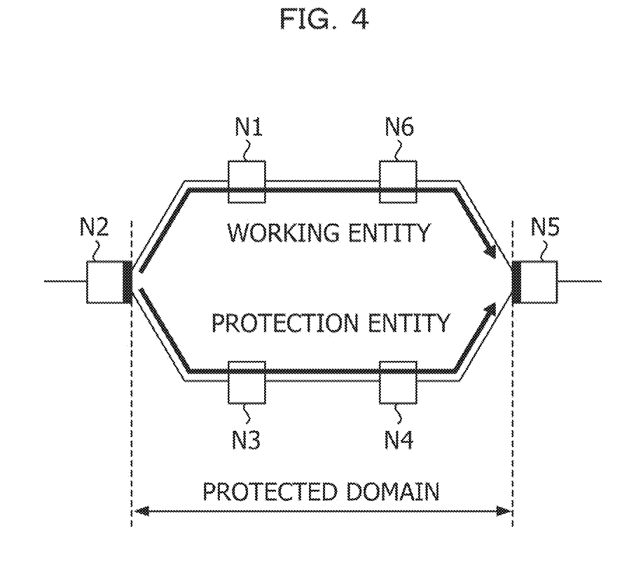

FIGS. 5A and 5B are diagrams illustrating a problem caused by a protection switching operation performed in a HO-ODU level;

FIG. 6 is a diagram illustrating a configuration of a network according to a first embodiment;

FIG. 7 is a diagram illustrating a ring protection function applied to the network according to the first embodiment;

FIG. 8 is a block diagram illustrating a general configuration of each node included in the network according to the first embodiment;

FIG. 9 is a flowchart illustrating an entire processing operation performed at a time of a network failure, in a node according to an embodiment;

FIG. 10 is a diagram illustrating operation patterns performed at a time of a network failure, in the node according to the embodiment;

FIGS. 11A to 11C are diagrams illustrating an effect of a processing operation performed at a time of a network failure, in the node according to the embodiment;

FIG. 12 is a block diagram illustrating an example of configuration of a node according to a second embodiment;

FIG. 13 is a diagram illustrating an operation performed in the node according to the second embodiment;

FIG. 14 is a diagram illustrating an operation performed in the node according to the second embodiment;

FIG. 15 is a diagram illustrating an operation performed in the node according to the second embodiment;

FIG. 16 is a diagram illustrating an operation performed in the node according to the second embodiment;

FIG. 17 is a diagram illustrating an operation performed in the node according to the second embodiment;

FIG. 18 is a diagram illustrating an operation performed in the node according to the second embodiment;

FIGS. 19A and 19B are diagrams illustrating an example of a failure notification method performed in a network according to a third embodiment;

FIG. 20 is a diagram illustrating an example of an acquisition method for topology information, performed in a network according to a fourth embodiment;

FIGS. 21A and 21B are diagrams illustrating an example of an acquisition method for path information of LO-ODU, performed in the network according to the fourth embodiment; and

FIG. 22 is a diagram illustrating an example of a notification of failure point information in the network according to the fourth embodiment.

### DESCRIPTION OF EMBODIMENTS

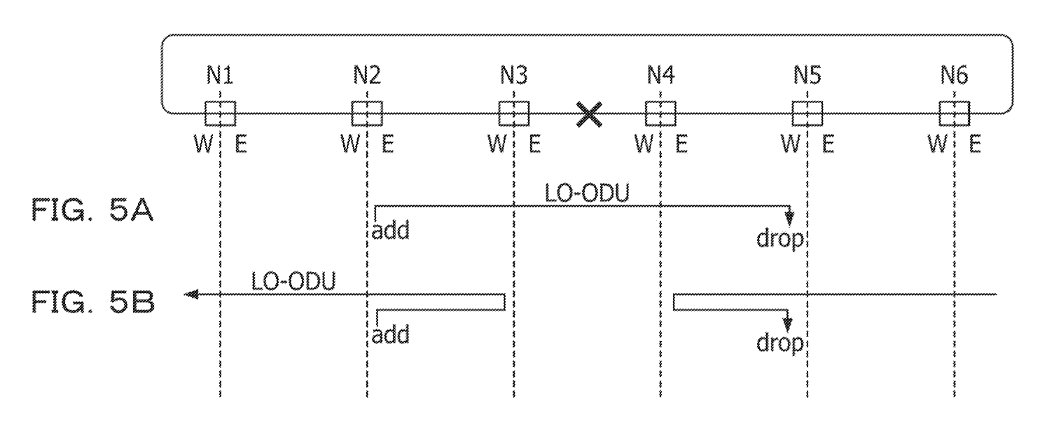

It may be assumed that a ring protection function for SONET/SDH is applied to the above-mentioned HO/LO-ODU. For example, the HO-ODU is terminated between adjacent nodes, and the same operation as a bidirectional line switched ring (BLSR) can be applied to individual nodes in an HO-ODU level. The LO-ODU is added or dropped at an arbitrary node. At this time, when a failure occurs in a path through which the HO-ODU is transmitted in an actually used line, a protection switch functions, and hence the HO-ODU is sent out to a backup line in a direction opposite to the transmission direction of the actually used line. In the case in which the ring protection function is configured in this way, the transmission path through which the LO-ODU, mapped to the HO-ODU, is transmitted in a network results in returning at a failure end as a result, owing to the protection switching operation performed in the HO-ODU level. By the way, in such a configuration of the ring protection function, the path of the LO-ODU becomes redundant owing to the protection switching operation performed in the HO-ODU level, and hence a great transmission delay may occur. This point will be described with reference to FIGS. 5A and 5B.

FIGS. 5A and 5B are diagrams illustrating a problem caused by the protection switching operation performed in the HO-ODU level, in a network that includes, for example, six nodes N1 to N6. In FIGS. 5A and 5B, the west side of each node is expressed as “W”, and the east of each node is expressed as “E”. In the example illustrated in FIGS. 5A and 5B, a transmission path between the node N3 and the node N4 is a failure point. FIG. 5A illustrates an example of the path of the LO-ODU when no failure occurs in the transmission path in the network (in a normal state). The example illustrates a path in which the LO-ODU is transmitted (added) from the east side of the node N2, is to be sequentially transmitted through the node N3, N4, and N5 in this order, and is to be received (dropped) at the west side of the node N5. At this time, the LO-ODU that is a transmission/reception object is mapped to the HO-ODU, and the HO-ODU is transmitted through the actually used line between the nodes. In addition, the HO-ODU to be transmitted is terminated at individual nodes.

FIG. 5B illustrates a path through which the LO-ODU is transmitted when the protection switching operation is performed in the HO-ODU level in a case in which a failure occurs in the transmission path in the network. In this case, the LO-ODU is transmitted (added) from the east side of the node N2, and the HO-ODU that contains the LO-ODU is transmitted to the node N3. Since the node N3 is a failure end, the transmitted HO-ODU is returned to the backup line, and is transmitted through the nodes N2→N1→N6→N5→N4 in this order. In addition, since the node N4 is a failure end, the HO-ODU transmitted through the backup line is returned to the actually used line to be transmitted to the node N5. Finally, the LO-ODU is received (dropped) at the west of the node N5. When FIG. 5A is compared with FIG. 5B, clearly, the path of the LO-ODU at the time of a failure occurrence becomes redundant between the node N2 and the node N3 and between the node N4 and the node N5. Therefore, the transmission delay of the LO-ODU, namely a client signal, occurs at the time of a failure occurrence. The path redundancy of signal transmission is also undesirable from the view point of usage efficiency.

Therefore, according to the present invention, there are provided a signal transmission method and a transmission device, in which a signal transmission delay between nodes is suppressed when a failure occurs in a transmission path in a network in which a plurality of nodes are connected in a ring shape.

From the first standpoint, there is provided the signal transmission method for transmitting a signal in a network wherein a plurality of nodes are connected in a ring shape, the signal is capable of being transmitted from individual nodes in first and second directions toward adjacent nodes, and an actually used line and a backup line are provided in each of the transmission directions. The signal transmission method includes causing each of the plurality of nodes to transfer, using the actually used line, a second signal in a second layer, in which one or a plurality of first signals in a first layer are contained, to a node adjacent in the first or the second direction when each of the plurality of nodes transmits or receives the first signal, when no failure occurs in a transmission path in the network; and causing a first node, located at an end of a failure point, to switch a transmission direction of the second signal and to send out the second signal to the backup line, and causing a second node, which is a transmission source or a reception destination of the first signal, to select one of the first and second directions as the transmission direction or reception direction of the first signal so that a path for the first signal circumvents the failure point, when a failure occurs in the transmission path in the network.

Form the second standpoint, there is provided the transmission device for transmitting a signal in a network including a plurality of transmission devices connected in a ring shape, the signal is capable of being transmitted from individual transmission devices in first and second directions toward adjacent nodes, and an actually used line and a backup line are provided in each of the transmission directions. The transmission device includes: a transmission and reception section to transfer, using the actually used line, a second signal in a second layer, in which one or a plurality of first signals in a first layer are contained, to a transmission device adjacent in the first or the second direction when the first signal is transmitted or received, in a case in which no failure occurs in a transmission path in the network; a first processing section to switch a transmission direction of the second signal and send out the second signal to the backup line, when a failure occurs in the transmission path in the network and the transmission device is located at an end of a failure point; and a second processing section to select one of the first and second directions as the transmission direction or reception direction of the first signal so that a path for the first signal circumvents the failure point, when the failure occurs and the transmission device is a transmission source or a reception destination of the first signal.

According to the signal transmission method and the transmission device, which are disclosed, a signal transmission delay between nodes can be suppressed when a failure occurs in a transmission path in a network in which a plurality of nodes are connected in a ring shape.

(1-1) Configuration of Network

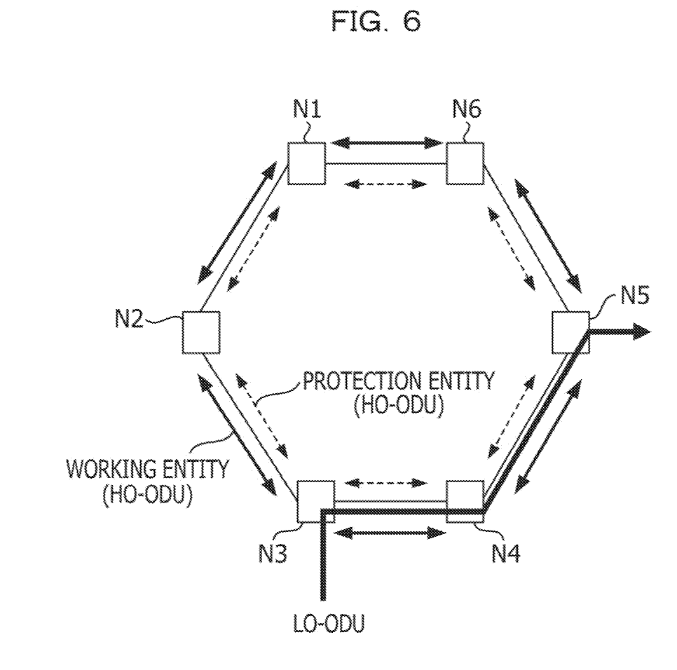

An optical transmission network (simply referred to as “network”, hereinafter) that is an example of a ring network in which a plurality of nodes are connected in a ring shape will be described hereinafter. FIG. 6 is a diagram illustrating the general configuration of a network according to an embodiment. In addition, for example, individual nodes correspond to transmission devices such as an optical cross connect or the like.

As illustrated in FIG. 6, in the network according to the embodiment, a plurality of nodes (six nodes N1 to N6 in the example illustrated in FIG. 6) are connected in a ring shape, using an optical fiber. In this network, a working entity (referred to as “actually used line” hereinafter) and a protection entity (referred to as “backup line” hereinafter) are provided. A client signal is mapped to the LO-ODU at individual nodes. The LO-ODU can be transmitted and received (added/dropped) at an arbitrary node. The actually used line and the backup line are provided for the HO-ODU (a second signal in a second layer) in which one or a plurality of LO-ODUs (a first signal in a first layer) are multiply contained. In this network, the HO-ODU is terminated between adjacent nodes in both the actually used line and backup line, and hence the HO-ODU does not pass through the actually used line at individual nodes. Therefore, after the HO-ODU to which the LO-ODU is mapped is terminated at an adjacent node, the LO-ODU that is an upper layer over the HO-ODU is mapped to the new HO-ODU again at the adjacent node.

For example, in the example illustrated in FIG. 6, a case in which the client signal is transmitted (added) from the node N3 and is received (dropped) at the node N5 is illustrated. In this case, the client signal is mapped to the LO-ODU at the node N3, and furthermore the LO-ODU is mapped to the HO-ODU along with other LO-ODUs. The HO-ODU is sent out from the node N3 to the node N4, and is terminated at the node N4. The HO-ODU to which the LO-ODU received from the node N3 is mapped is newly generated at the node N4, and is sent out to the node N5. In addition, the HO-ODU transferred from the node N4 is terminated at the node N5, and the LO-ODU is extracted from the HO-ODU, thereby the client signal being received (dropped).

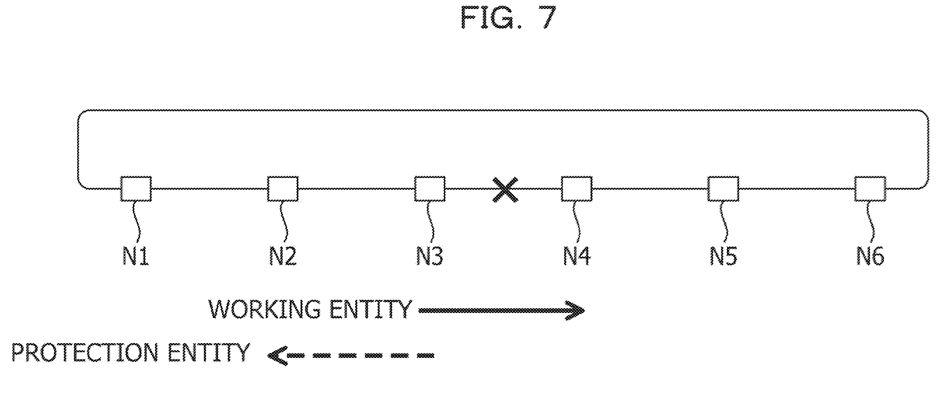

As illustrated in FIG. 6, the actually used line and the backup line are configured so that the HO-ODU can be transmitted from a node in two directions toward two adjacent nodes (first and second directions). In addition, as illustrated in FIG. 7, a ring protection function applied to the network according to the embodiment is configured so that, regarding the actually used line (working entity) in one direction, a signal can be transmitted through the backup line (protection entity) in a direction opposite to the direction of the actually used line.

In the network, the same operation as a bidirectional line switched ring (BLSR) is applied to the ring protection function performed in the HO-ODU level between adjacent nodes. In the example illustrated in FIG. 7, for example, when a failure occurs in the transmission path between the node N3 and the node N4, the HO-ODU is transmitted to the node N2 through the backup line the direction of which is opposite to that of the actually used line. While the HO-ODU is terminated between adjacent nodes in the network, the transmission path through which the LO-ODU, mapped to the HO-ODU, is transmitted in the network results in returning at a failure end as a result, owing to the protection switching operation performed in the HO-ODU level.

(1-2) Configuration of Node

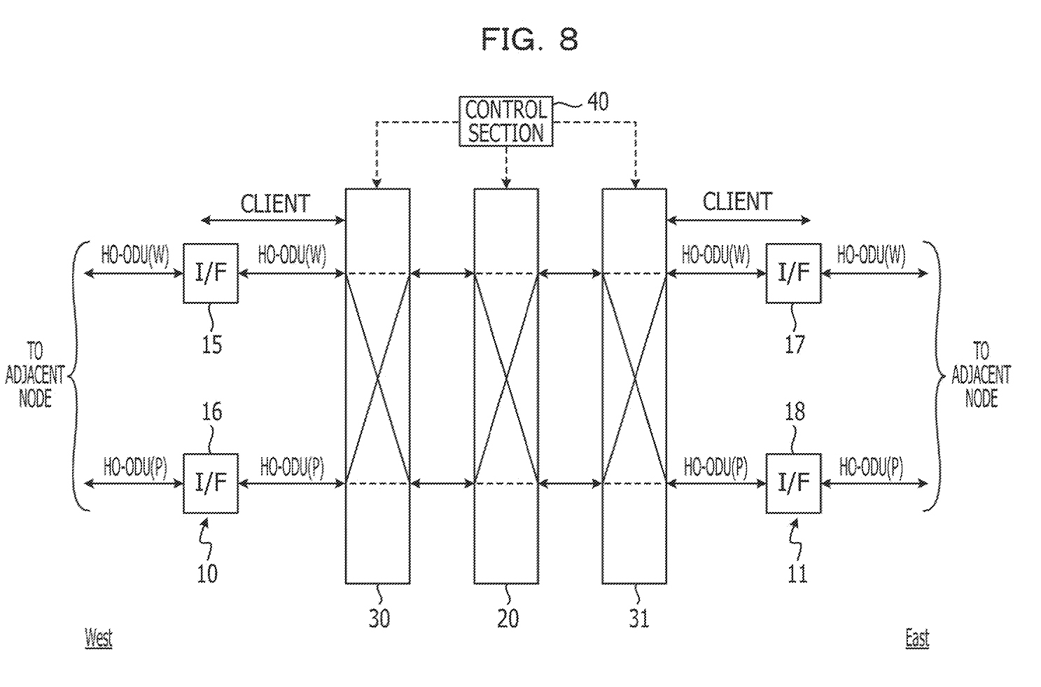

The general configuration of each node included in the network according to the embodiment is illustrated with reference to FIG. 8. As illustrated in FIG. 8, the node according to the embodiment includes a first processing section 20, a transmission and reception section (West) 10 and a second processing section (West) 30, arranged at the west side, a transmission and reception section (East) 11 and a second processing section (East) 31, arranged at the east side, and a control section 40. In addition, in FIG. 8, a HO-ODU (W) indicates the HO-ODU transmitted through the actually used line, and a HO-ODU (P) indicates the HO-ODU transmitted through the backup line.

The transmission and reception section (West) 10 includes a transmitting and receiving circuit for sending out a signal from the west side to the transmission path in the network and receiving a signal at the west side, and interface sections 15 and 16 that include signal conversion circuits for performing conversion between an optical signal and an electrical signal, or the like. The interface section 15 is arranged for a signal transmitted through the actually used line, and the interface section 16 is arranged for a signal transmitted through the backup line. The transmission and reception section (East) 11 includes a transmitting and receiving circuit for sending out a signal from the east side to the transmission path in the network and receiving a signal at the east side, and interface sections 17 and 18 that include signal conversion circuits for performing conversion between an optical signal and an electrical signal, or the like. The interface section 17 is arranged for a signal transmitted through the actually used line, and the interface section 18 is arranged for a signal transmitted through the backup line.

When a failure occurs in the transmission path in the network and the node in which the first processing section 20 is arranged is located at the end of the transmission path in which the failure occurs, the first processing section 20 practically operates. In addition, in the following description, a node located at the end of a transmission path in which a failure occurs is called “failure end” (first node). For example, in FIG. 7, when a failure occurs in the transmission path between the node N3 and the node N4, the node N3 and the node N4 correspond to the failure ends in the network.

When the node in which the first processing section 20 is arranged is the failure end, the first processing section 20 operates. On the basis of an instruction from the control section 40, the first switch section 20 performs a switching operation in which the transmission direction of the signal is switched from the actually used line to the backup line in units of HO-ODUs, or the transmission direction of the signal is switched from the backup line to the actually used line in units of HO-ODUs.

The first processing section 20 performs a termination processing operation for the HO-ODU (W) and the HO-ODU (P). For example, when it is assumed that the HO-ODU (W) is transferred from the west side of the node to the east side thereof, the HO-ODU (W) received from the west side through the actually used line is terminated at the first processing section 20. In addition, the first processing section 20 newly generates the HO-ODU (W), and sends out the HO-ODU (W) from the east side.

When the node in which the second processing section (West) 30 is arranged is a transmitting node (referred to as “transmitting end” hereinafter) for the client signal (namely, the LO-ODU to which the client signal is mapped) or a receiving node (referred to as “receiving end” hereinafter), the second processing section (West) 30 operates. A node that is a transmitting end or a receiving end is collectively called “transmitting/receiving end” (second node).

When the node in which the second processing section (West) 30 is arranged is the transmitting end, the second processing section (West) 30 generates the LO-ODU on the basis of the client signal. In addition, the second processing section (West) 30 switches the transmission direction of the LO-ODU (a direction in which the LO-ODU is sent out from the east side through the actually used line, or a direction in which the LO-ODU is sent out from the west side through the backup line) in units of LO-ODUs. When the second processing section (West) 30 sends out the LO-ODU, the second processing section (West) 30 multiplexes one or a plurality of LO-ODUs into the HO-ODU, and outputs the HO-ODU. When the node in which the second processing section (West) 30 is arranged is the receiving end, the second processing section (West) 30 separates the LO-ODU from the HO-ODU transferred from an adjacent node. At this time, the second switch section (West) 30 switches the reception direction of the LO-ODU (a direction in which the LO-ODU is received from the west side through the actually used line, or a direction in which the LO-ODU is received from the east side through the backup line) in units of LO-ODUs. In addition, the second processing section (West) 30 extracts the client signal from the received LO-ODU.

In the second processing section (East) 31, the same processing operation as the second processing section (West) 30 is performed at the east side. At this time, when the node in which the second switch section (East) 31 is arranged is the transmitting end, the second switch section (East) 31 switches the transmission direction of the LO-ODU (a direction in which the LO-ODU is sent out from the west side through the actually used line, or a direction in which the LO-ODU is sent out from the east side through the backup line) in units of LO-ODUs. In addition, when the node in which the second switch section (East) 31 is arranged is the receiving end, the second switch section (East) 31 switches the reception direction of the LO-ODU (a direction in which the LO-ODU is received from the east side through the actually used line, or a direction in which the LO-ODU is received from the west side through the backup line) in units of LO-ODUs. In addition, the switching processing operations performed in the second processing section (West) 30 and the second processing section (East) 31 are performed under the instruction of the control section 40. Namely, on the basis of the overhead information or the like of the LO-ODU and/or the HO-ODU that are processing objects, the control section 40 controls the second switch section (West) 30 and the second switch section (East) 31 so that the LO-ODU is transmitted in a desired transmission/reception direction.

In the node illustrated in FIG. 8, the switching processing operation performed in units of LO-ODUs when the node is the transmitting/receiving end and the switching processing operation performed in units of HO-ODUs when the node is the failure end are performed at the west side and the east side independently from each other.

(1-3) Processing Operation Performed in Each Node when Failure Occurs in Transmission Path

As described above, in the case in which a failure occurs in the transmission path in the network, a switching processing operation (referred to as “failure end switching processing operation”, hereinafter) in the HO-ODU level is performed in each node when the node is the failure end. In addition, when the node is the transmitting/receiving end, a switching processing operation (referred to as “transmitting/receiving end switching processing operation”, hereinafter) in the LO-ODU level is performed. The failure end switching processing operation and the transmitting/receiving end switching processing operation will be described in further detail hereinafter.

(A) Failure End Switching Processing Operation

In the failure end switching processing operation, the HO-ODU transferred through the actually used line is returned (namely, transmitted in a direction opposite to the transfer direction) and is sent out to the backup line, or the HO-ODU transferred through the backup line is returned (namely, transmitted in a direction opposite to the transfer direction) and is sent out to the actually used line. At the failure end, this processing operation is performed at the west side and the east side independently from each other. For example, in FIG. 8, the HO-ODU (W) transferred from the west side through the actually used line is subjected to a switching processing operation performed in the first processing section 20, and, as a result, the HO-ODU (P) is sent out from the west side through the backup line. The HO-ODU (P) transferred from the west side through the backup line is subjected to a switching processing operation performed in the first processing section 20, and, as a result, the HO-ODU (W) is sent out from the west side through the actually used line. In the same way, in FIG. 8, the HO-ODU (W) transferred from the east side through the actually used line is subjected to a switching processing operation performed in the first processing section 20, and, as a result, the HO-ODU (P) is sent out from the east side through the backup line. The HO-ODU (P) transferred from the east side through the backup line is subjected to a switching processing operation performed in the first processing section 20, and, as a result, the HO-ODU (W) is sent out from the east side through the actually used line.

(B) Transmitting/Receiving End Switching Processing Operation

In the transmitting/receiving end switching processing operation, when a failure occurs in the transmission path, the control section 40 selects a transmission direction (in the case of a transmitting end) or a reception direction (in the case of a receiving end) so that a path through which the LO-ODU that is an object for transmission/reception (add/drop) is transmitted is an optimum path. The selection operation is performed on the basis of whether or not a transmission path in which a failure occurs (referred to as “failure point” hereinafter) exists in a path to be used when no failure occurs in a transmission path in the network (namely, in a normal state). Namely, the selection operation is performed so that a path, through which the LO-ODU that is a transmission/reception object is transmitted, circumvents the failure point. At the transmitting/receiving end, this processing operation is performed at the west side and the east side independently from each other.

In the network according to the embodiment, when a failure occurs in the transmission path in the network, individual nodes can share information relating to the failure point (referred to as “failure point information” hereinafter). For example, a failure end writes, into an overhead in an HO-ODU, information that indicates the occurrence of a failure, and the HO-ODU is transferred through the network to notify other nodes of the occurrence of a failure. Accordingly, the sharing of the failure point information is performed. In the embodiment, on the basis of the failure point information, the control section 40 selects a transmission direction or a reception direction for each LO-ODU to be a control object (namely, LO-ODU to be an object for transmission/reception (add/drop)). The second switch section (West) 30 and the second switch section (East) 31 are instructed to switch in response to the selection result.

Here, first, in FIG. 8, it may be assumed that the node is the transmitting end of the LO-ODU. When a failure occurs in the transmission path, the control section 40 controls the second switch section (West) 30 or the second switch section (East) 31 so that the LO-ODU that is a transmission object is sent out through the actually used line without the transmission direction thereof being switched, or is sent out through the backup line with the transmission direction thereof being switched.

Specifically, regarding the client signal input from the west side, when a direction in which a corresponding LO-ODU is sent out from the east side through the actually used line is selected, the second switch section (West) 30 performs a switching operation so that the LO-ODU that is a transmission object is mapped to the HO-ODU (W) to be transmitted from the east side through the actually used line. Regarding the client signal input from the west side, when a direction in which a corresponding LO-ODU is sent out from the west side through the backup line is selected, the second switch section (West) 30 performs a switching operation so that the LO-ODU that is a transmission object is mapped to the HO-ODU (P) to be transmitted from the west side through the backup line.

In addition, regarding the client signal input from the east side, when a direction in which a corresponding LO-ODU is sent out from the west side through the actually used line is selected, the second switch section (East) 31 performs a switching operation so that the LO-ODU that is a transmission object is mapped to the HO-ODU (W) to be transmitted from the west side through the actually used line. Regarding the client signal input from the east side, when a direction in which a corresponding LO-ODU is sent out from the east side through the backup line is selected, the second switch section (East) 31 performs a switching operation so that the LO-ODU that is a transmission object is mapped to the HO-ODU (P) to be transmitted from the east side through the backup line.

Next, in FIG. 8, it may be assumed that the node is the receiving end of the LO-ODU. When a failure occurs in the transmission path, the control section 40 controls the second switch section (West) 30 or the second switch section (East) 31 so that the LO-ODU that is a reception object is received through the actually used line without the reception direction thereof being switched, or is received through the backup line with the reception direction thereof being switched.

Specifically, regarding the client signal output from the west side, when a direction in which a corresponding client signal is received from the west side through the actually used line is selected, the second switch section (West) 30 performs a switching operation so that the LO-ODU that is a reception object is demapped from the HO-ODU (W) received from the west side through the actually used line. Regarding the client signal output from the west side, when a direction in which a corresponding client signal is received from the east side through the backup line is selected, the second switch section (West) 30 performs a switching operation so that the LO-ODU that is a reception object is demapped from the HO-ODU (P) received from the east side through the backup line.

In addition, regarding the client signal output from the east side, when a direction in which a corresponding client signal is received from the east side through the actually used line is selected, the second switch section (East) 31 performs a switching operation so that the LO-ODU that is a reception object is demapped from the HO-ODU (W) received from the east side through the actually used line. Regarding the client signal output from the east side, when a direction in which a corresponding client signal is received from the west side through the backup line is selected, the second switch section (East) 31 performs a switching operation so that the LO-ODU that is a reception object is demapped from the HO-ODU (P) received from the west side through the backup line.

(1-4) Entire Flow of Processing Operation Performed in Each Node and Operation of Network

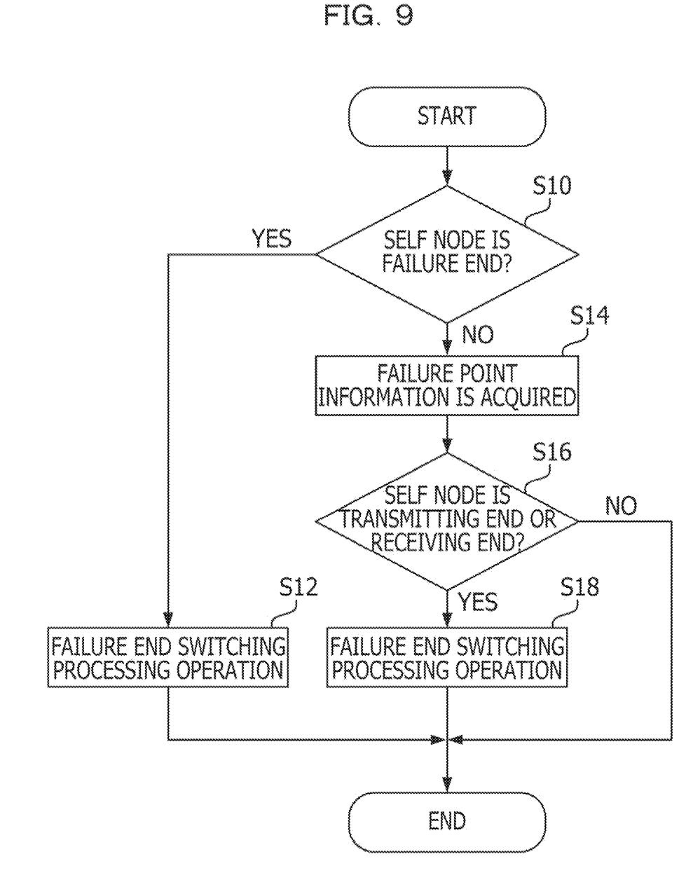

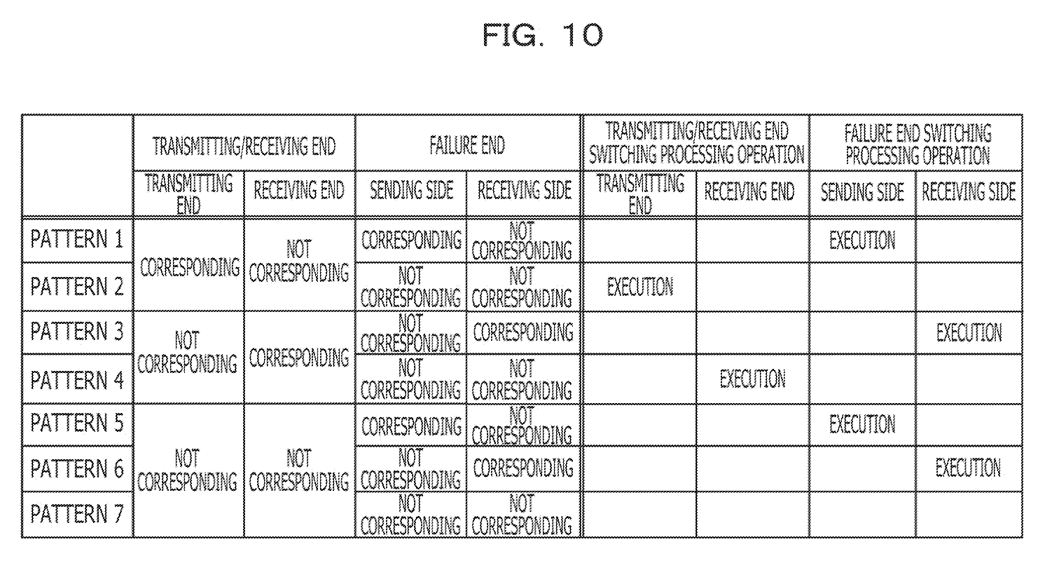

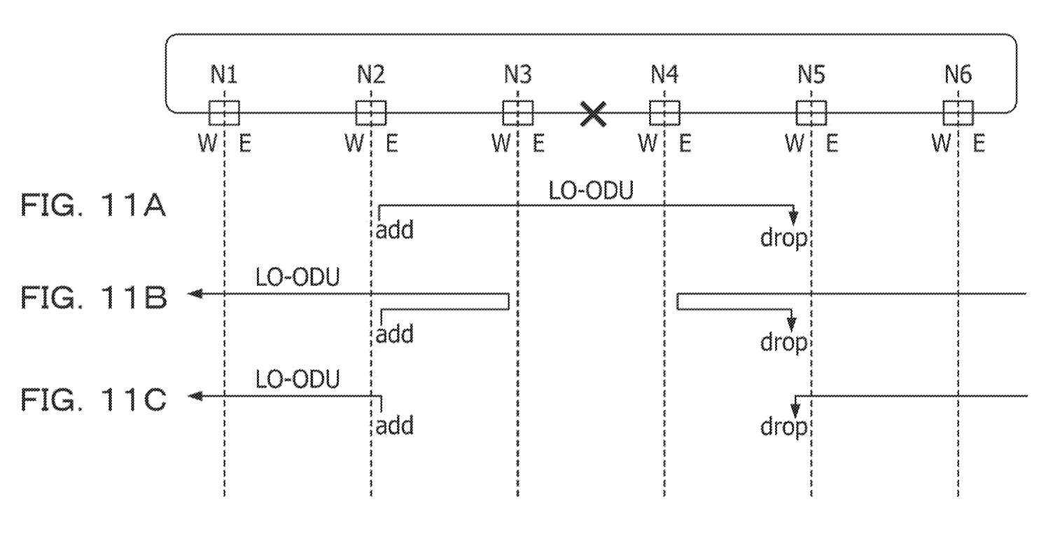

Next, the entire processing operation of each node and the operation of the network, performed when a failure occurs in the transmission path in the network, will be described with reference to FIGS. 9 to 11. FIG. 9 is a flowchart illustrating an entire processing operation performed in the node according to the embodiment when a failure occurs in the transmission path in the network. FIG. 10 is a diagram illustrating operation patterns performed in the node according to the embodiment when a failure occurs in the transmission path in the network. FIGS. 11A to 11C are diagrams illustrating the effect of a processing operation performed in the node according to the embodiment when a failure occurs in the transmission path in the network.

In FIG. 9, first, on the basis of the signal quality of a physical layer level, the node according to the embodiment determines whether or not the node is a failure end (Step S10). The determination is performed at the west side and the east side independently from each other. When the node is the failure end, the failure end switching processing operation is executed in units of HO-ODUs (Step S12). In addition, when the node is the failure end, the node writes, into an overhead in an HO-ODU, information that indicates the occurrence of a failure, for example, and the HO-ODU is transferred through the network. Accordingly, the node notifies other nodes that the node is the failure end.

Each node acquires failure point information on the basis of the information, which is given notice of by another node and indicates the occurrence of a failure, when the node is not the failure end (Step S14). Namely, a plurality of nodes in the network share the failure point information. Next, in each node, when the node is a transmitting/receiving end (Step S16: YES), the transmitting/receiving end switching processing operation is executed in units of LO-ODUs (Step S18). Namely, the transmission direction or reception direction of the LO-ODU is switched as necessary so that a path, through which the LO-ODU that is a transmission/reception object is transmitted, circumvents the failure point.

Next, the behavior of a switching processing operation that is assumed in response to the states of each node in the network, has seven patterns, and is performed in each node is illustrated with reference to FIG. 10. When a failure occurs in the transmission path in the network, each node in the network turns out to correspond to one of the seven patterns. Here, as described with reference to FIG. 9, when the node is the failure end (regardless of a sending side for a signal or a receiving side for a signal) (pattern 1, 3, 5, or 6), the failure end switching processing operation is executed. When the node is not the failure end but is the transmitting/receiving end (pattern 2 or 4), the transmitting/receiving end switching processing operation is executed. When the node is neither the failure end nor the transmitting/receiving end (pattern 7), no processing operation is executed.

Next, the effect of a processing operation, performed in the node according to the embodiment when a failure occurs in the transmission path in the network that includes, for example, six nodes N1 to N6 will be described with reference to FIGS. 11A to 11C. In FIGS. 11A to 11C, the west side of each node is expressed as “W”, and the east side of each node is expressed as “E”. In FIGS. 11A to 11C, a case in which a transmission path between the node N3 and the node N4 is a failure point is illustrated as an example. FIG. 11A illustrates an example of the path of the LO-ODU in the case in which no failure is assumed to occur in the transmission path in the network (in a normal state). In the example, the LO-ODU is to be transmitted (added) from the east side of the node N2, is to be sequentially transmitted through the node N3, N4, and N5 in this order, and is to be received (dropped) at the west side of the node N5. At this time, the LO-ODU that is a transmission/reception object is mapped to the HO-ODU, and the HO-ODU is transmitted between nodes through the actually used line.

In order to be compared with FIG. 11C, FIG. 11B illustrates the path of the LO-ODU in the case in which a transmitting/receiving end is assumed not to perform the transmitting/receiving end switching processing operation. In this case, the LO-ODU is transmitted (added) from the east side of the node N2 that is a transmitting end, and the HO-ODU to which the LO-ODU is mapped is transmitted to the node N3. Since the node N3 is a failure end, the transmitted HO-ODU is returned to the backup line, and is transmitted through the nodes N2→N1→N6→N5→N4 in this order. In addition, since the node N4 is a failure end, the HO-ODU transmitted through the backup line is returned to the actually used line, and is transmitted to the node N5. Finally, the LO-ODU is received (dropped) at the west side of the node N5.

FIG. 11C illustrates the path of the LO-ODU in the node according to the embodiment. Namely, the transmitting/receiving end switching processing operation is executed at the nodes N2 and N5 that are transmitting/receiving ends. In the embodiment, each node can acquire failure point information (in the example illustrated in FIG. 11, information indicating that the transmission path between the node N3 and the node N4 is a failure point) on the basis of information, which is given notice of by another node and indicates the occurrence of a failure, when the node is not the failure end. In addition, the node N2 switches the sending direction of the LO-ODU so that a path, through which the LO-ODU to be a transmission object is transmitted, circumvents the failure point. Accordingly, the LO-ODU to be a transmission object is mapped to the HO-ODU to be transmitted to the node N1 through the backup line. This HO-ODU is transmitted through the nodes N1→N6→N5 in this order. The node N5 that is a receiving end receives (drops) the LO-ODU to be a reception object from the HO-ODU received from a direction that circumvents the failure point. Namely, the node N5 that is a receiving end demaps the LO-ODU, which is a reception object, from the HO-ODU transmitted from the node N6 through the backup line.

While, in the case illustrated in FIG. 11B, redundant transmission occurs between the node N2 and the node N3 and between the node N4 and the node N5, such redundant transmission does not occur in the embodiment, as illustrated in FIG. 11C. In other words, in the network according to the embodiment, when a failure occurs in the transmission path, the transmission/reception path of the LO-ODU is optimized.

As described above, in the network according to the embodiment, a ring protection function is applied in the HO-ODU level. In addition, when a failure occurs in the transmission path in the network, the failure end switching processing operation in which the HO-ODU level is returned from the actually used line to the backup line is performed at a failure end. Furthermore, at the transmitting/receiving end of the LO-ODU, the transmitting/receiving end switching processing operation in which the transmission direction or reception direction of the LO-ODU is switched as necessary is performed so that the path of the LO-ODU is optimized. Therefore, when the failure of the transmission path occurs, the path of the LO-ODU turns out not to be a path that returns at the failure end. Accordingly, when the failure of the transmission path occurs, the transmission delay time of the client signal is suppressed and the usage efficiency of the bandwidth of the network is improved.

The second embodiment will be described hereinafter. In the second embodiment, an example of the specific configuration of each node will be described in detail.

(2-1) Example of Specific Configuration of Node

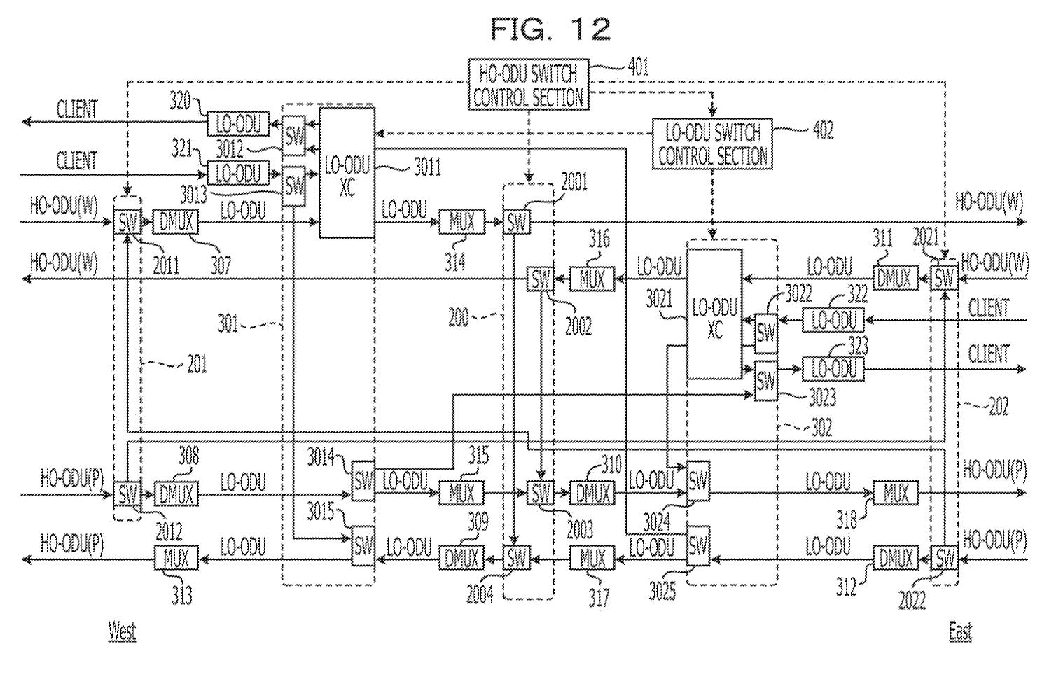

FIG. 12 is a block diagram illustrating an example of the specific configuration of each node. In addition, the configuration illustrated in FIG. 12 corresponds to the first processing section 20, the second processing section (West) 30, the second processing section (East) 31, and the control section 40 in the configuration illustrated in FIG. 8.

As illustrated in FIG. 12, the node according to the embodiment includes an LO-ODU processing section 320 that extracts the client signal contained in the payload of the LO-ODU that is a reception object and outputs the client signal from the west side. This node includes an LO-ODU processing section 321 that generates the LO-ODU that is a transmission object, on the basis of the client signal input from the west side. The node according to the embodiment includes an LO-ODU processing section 322 that generates the LO-ODU that is a transmission object, on the basis of the client signal input from the east side. The node includes an LO-ODU processing section 323 that extracts the client signal contained in the payload of the LO-ODU that is a reception object and outputs the client signal from the east side.

As illustrated in FIG. 12, the node according to the embodiment includes multiplexers (MUX) 313 to 318 that multiplex one or a plurality of LO-ODUs and generate the HO-ODUs with overheads being added thereto. In addition, the node includes demultiplexers (DMUX) 307 to 312 that separate one or a plurality of LO-ODUs from the HO-ODU.

The node according to the embodiment includes switch groups 200, 201, 202, 301, and 302. Here, the switch group 200 mainly performs the switching processing operation performed in the first processing section 20 illustrated in FIG. 8. The switch group 301 mainly performs the switching processing operation performed in the second processing section (West) 30 illustrated in FIG. 8. The switch group 302 mainly performs the switching processing operation performed in the second processing section (East) 31 illustrated in FIG. 8. As illustrated in FIG. 12, the switch group 200 includes switches (SW) 2001, 2002, 2003, and 2004. The switch group 201 includes switches 2011 and 2012. The switch group 202 includes switches 2021 and 2022. The switch group 301 includes a cross connect section (LO-ODUXC) 3011 and switches 3012, 3013, 3014, and 3015. The switch group 302 includes a cross connect section (LO-ODUXC) 3021 and switches 3022, 3023, 3024, and 3025.

An HO-ODU switch (HO-ODUSW) control section 401 mainly controls a switching operation at the HO-ODU level when the node is a failure end. The HO-ODU switch control section 401 collects overhead information in the HO-ODU to be processed in the node. On the basis of the overhead information in the HO-ODU, the HO-ODU switch control section 401 determines a switching operation performed at the HO-ODU level. On the basis of the determination, control signals are transmitted to the switch groups 200, 201, and 202. In individual switch groups, the operations of switches are controlled on the basis of the control signals.

An LO-ODU switch (LO-ODUSW) control section 402 mainly controls a switching operation at the LO-ODU level when the node is a transmitting/receiving end. The LO-ODU switch control section 402 collects overhead information in the LO-ODU to be processed in the node. On the basis of the overhead information in the HO-ODU, which is supplied from the HO-ODU switch control section 401, and the overhead information in the LO-ODU, the LO-ODU switch control section 402 determines a switching operation performed at the LO-ODU level. On the basis of the determination, control signals are transmitted to the switch groups 301 and 302. In individual switch groups, the operations of switches and cross connect sections are controlled on the basis of the control signals.

(2-2) Example of Operation Performed in Node

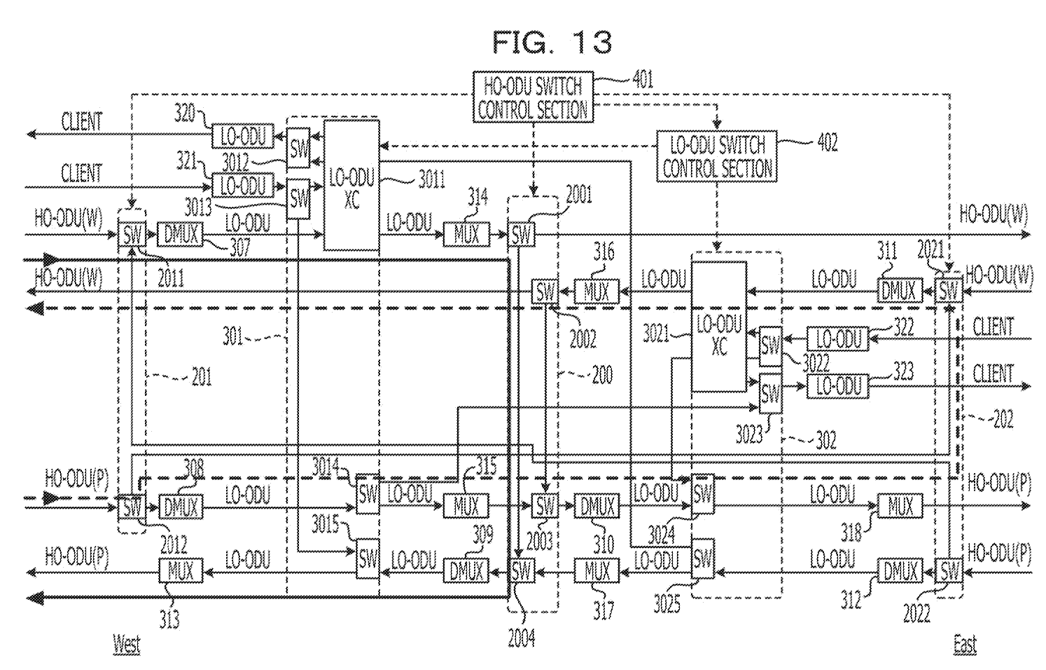

An example of the operation performed in the node will be described in several cases with reference to FIGS. 13 to 18, hereinafter.

(A) Failure End Switching Processing Operation Performed at West Side

A failure end switching processing operation performed at the west side will be described with reference to FIG. 13. In FIG. 13, the case in which a path is switched from the actually used line to the backup line at the west side in units of HO-ODUs is indicated using a bold solid line, and the case in which a path is switched from the backup line to the actually used line at the west side in units of HO-ODUs is indicated using a bold dotted line.

(A-1) Case in which Path is Switched from Actually Used Line to Backup Line at West Side

As indicated by the bold solid line in FIG. 13, the HO-ODU (W) transmitted from the west side through the actually used line is terminated at a failure end, is channeled through the switch 2011, and is separated into the LO-ODUs at the demultiplexer 307. The separated LO-ODUs are channeled to the multiplexer 314 by the cross connect section 3011. In the multiplexer 314, the HO-ODU is generated by multiplexing the LO-ODUs. The HO-ODU is channeled to the demultiplexer 309 through the switch 2001 and the switch 2004. The demultiplexer 309 separates the HO-ODU into the LO-ODUs. The separated LO-ODUs are channeled through the switch 3015, are multiplexed at the multiplexer 313, and are sent out as the HO-ODU (P) from the west side through the backup line.

(A-2) Case in which Path is Switched from Backup Line to Actually Used Line at West Side

As indicated by the bold dotted line in FIG. 13, the HO-ODU (P) transmitted from the west side through the backup line is terminated at a failure end, is channeled through the switches 2012 and 2021, and is separated into the LO-ODUs at the demultiplexer 311. The separated LO-ODUs are channeled to the multiplexer 316 by the cross connect section 3021. In the multiplexer 316, the HO-ODU is generated by multiplexing the LO-ODUs. The HO-ODU is channeled through the switch 2002, and is sent out as the HO-ODU (W) from the west side through the actually used line.

(B) Failure End Switching Processing Operation Performed at East Side

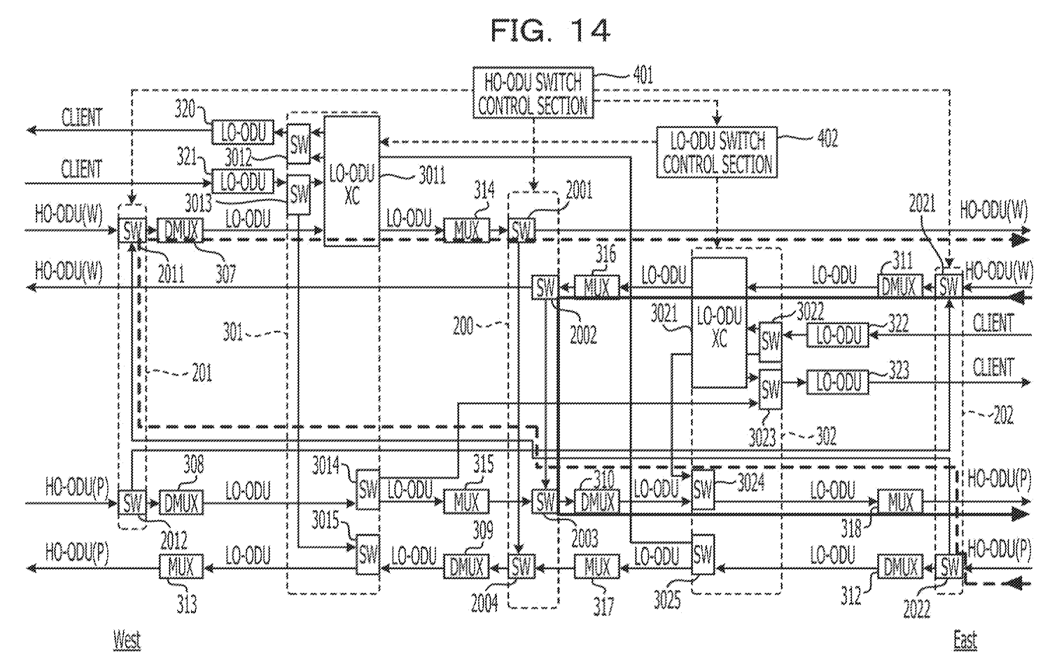

A failure end switching processing operation performed at the east side will be described with reference to FIG. 14. In FIG. 14, the case in which a path is switched from the actually used line to the backup line at the east side in units of HO-ODUs is indicated using a bold solid line, and the case in which a path is switched from the backup line to the actually used line at the east side in units of HO-ODUs is indicated using a bold dotted line.

(B-1) Case in which Path is Switched from Actually Used Line to Backup Line at East Side

As indicated by the bold solid line in FIG. 14, the HO-ODU (W) transmitted from the east side through the actually used line is terminated at a failure end, is channeled through the switch 2021, and is separated into the LO-ODUs at the demultiplexer 311. The separated LO-ODUs are channeled to the multiplexer 316 by the cross connect section 3021. In the multiplexer 316, the HO-ODU is generated by multiplexing the LO-ODUs. The HO-ODU is channeled to the demultiplexer 310 through the switch 2002 and the switch 2003. The demultiplexer 310 separates the HO-ODU into the LO-ODUs. The separated LO-ODUs are channeled through the switch 3024, are multiplexed at the multiplexer 318, and are sent out from the east side through the backup line.

(B-2) Case in which Path is Switched from Backup Line to Actually Used Line at East Side

As indicated by the bold dotted line in FIG. 14, the HO-ODU (P) transmitted from the east side through the backup line is terminated at a failure end, is channeled through the switches 2022 and 2011, and is separated into the LO-ODUs at the demultiplexer 307. The separated LO-ODUs are channeled to the multiplexer 314 by the cross connect section 3011. In the multiplexer 314, the HO-ODU is generated by multiplexing the LO-ODUs. The HO-ODU is channeled through the switch 2001, and is sent out as the HO-ODU (W) from the east side through the actually used line.

(C) Transmitting End Switching Processing Operation Relating to Client Signal Input from West Side

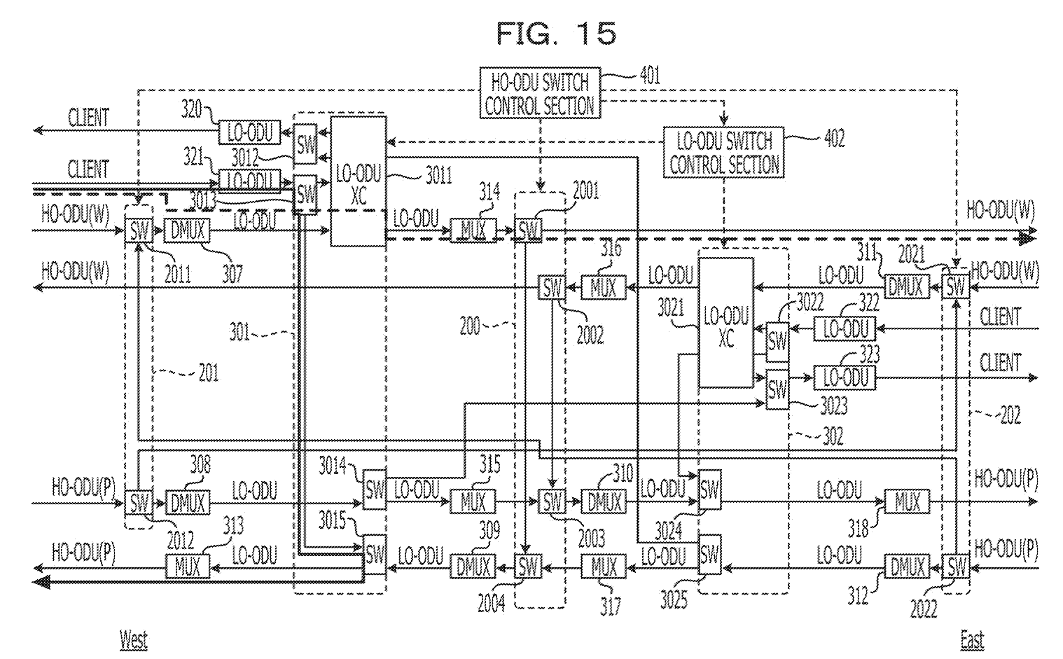

A transmitting end switching processing operation will be described with reference to FIG. 15. In FIG. 15, regarding the client signal input from the west side, the case where a direction in which the client signal is sent out from the east side through the actually used line is selected is indicated using a bold dotted line, and the case where a direction in which the client signal is sent out from the west side through the backup line is selected is indicated using a bold solid line.

(C-1) Case where Direction in which Client Signal is Sent Out from East Side through Actually Used Line is Selected

As indicated by the bold dotted line in FIG. 15, on the basis of the client signal input from the west side, the LO-ODU processing section 321 generates the LO-ODU that is a transmission object. The generated LO-ODU is channeled to the multiplexer 314 by the switch 3013 and the cross connect section 3011. The multiplexer 314 multiplexes one or a plurality of LO-ODUs that include the LO-ODU supplied from the cross connect section 3011, and generates the HO-ODU. The HO-ODU is channeled through the switch 2001, and is sent out as the HO-ODU (W) from the east side through the actually used line.

(C-2) Case where Direction in which Client Signal is Sent Out from West Side through Backup Line is Selected

As indicated by the bold solid line in FIG. 15, on the basis of the client signal input from the west side, the LO-ODU processing section 321 generates the LO-ODU that is a transmission object. The generated LO-ODU is channeled to the switch 3015 by the switch 3013, and is channeled to the multiplexer 313 through the switch 3015. The multiplexer 313 multiplexes one or a plurality of LO-ODUs that include the LO-ODU supplied from the switch 3015, and generates the HO-ODU. The HO-ODU is sent out as the HO-ODU (P) from the west side through the backup line.

(D) Transmitting End Switching Processing Operation Relating to Client Signal Input from East Side

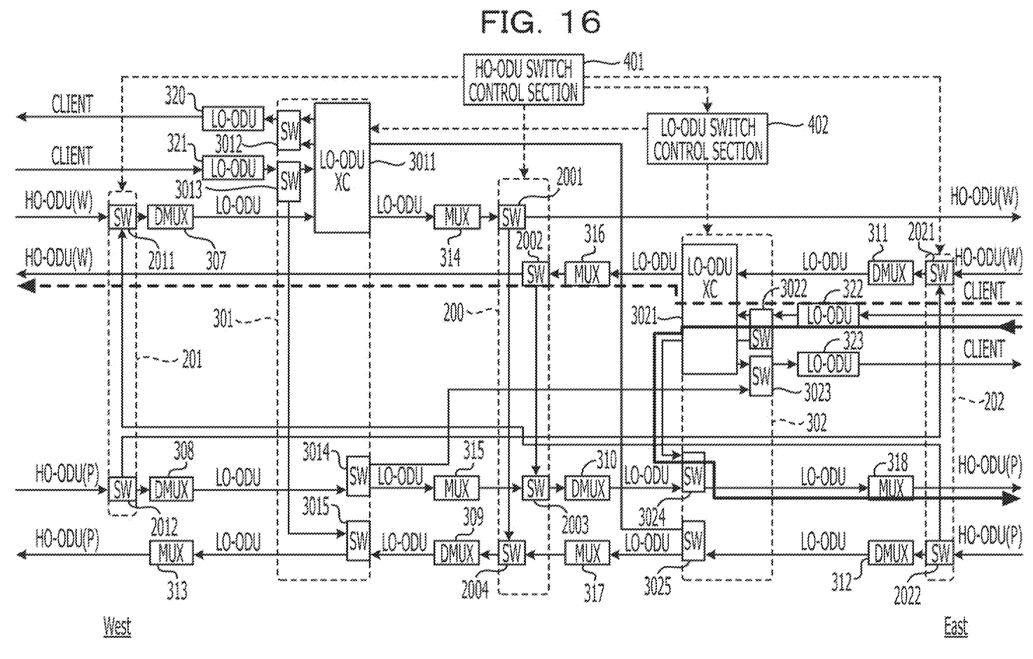

A transmitting end switching processing operation will be described with reference to FIG. 16. In FIG. 16, regarding the client signal input from the east side, the case where a direction in which the client signal is sent out from the west side through the actually used line is selected is indicated using a bold dotted line, and the case where a direction in which the client signal is sent out from the east side through the backup line is selected is indicated using a bold solid line.

(D-1) Case where Direction in which Client Signal is Sent Out from West Side through Actually Used Line is Selected

As indicated by the bold dotted line in FIG. 16, on the basis of the client signal input from the east side, the LO-ODU processing section 322 generates the LO-ODU that is a transmission object. The generated LO-ODU is channeled to the multiplexer 316 by the switch 3022 and the cross connect section 3021. The multiplexer 316 multiplexes one or a plurality of LO-ODUs that include the LO-ODU supplied from the cross connect section 3021, and generates the HO-ODU. The HO-ODU is channeled through the switch 2002, and is sent out as the HO-ODU (W) from the west side through the actually used line.

(D-2) Case where Direction in which Client Signal is Sent Out from East Side through Backup Line is Selected

As indicated by the bold solid line in FIG. 16, on the basis of the client signal input from the east side, the LO-ODU processing section 322 generates the LO-ODU that is a transmission object. The generated LO-ODU is channeled to the multiplexer 318 by the switch 3022, the cross connect section 3021, and the switch 3024. The multiplexer 318 multiplexes one or a plurality of LO-ODUs that include the LO-ODU supplied from the switch 3024, and generates the HO-ODU. The HO-ODU is sent out as the HO-ODU (P) from the east side through the backup line.

(E) Receiving End Switching Processing Operation Relating to Client Signal Output to West Side

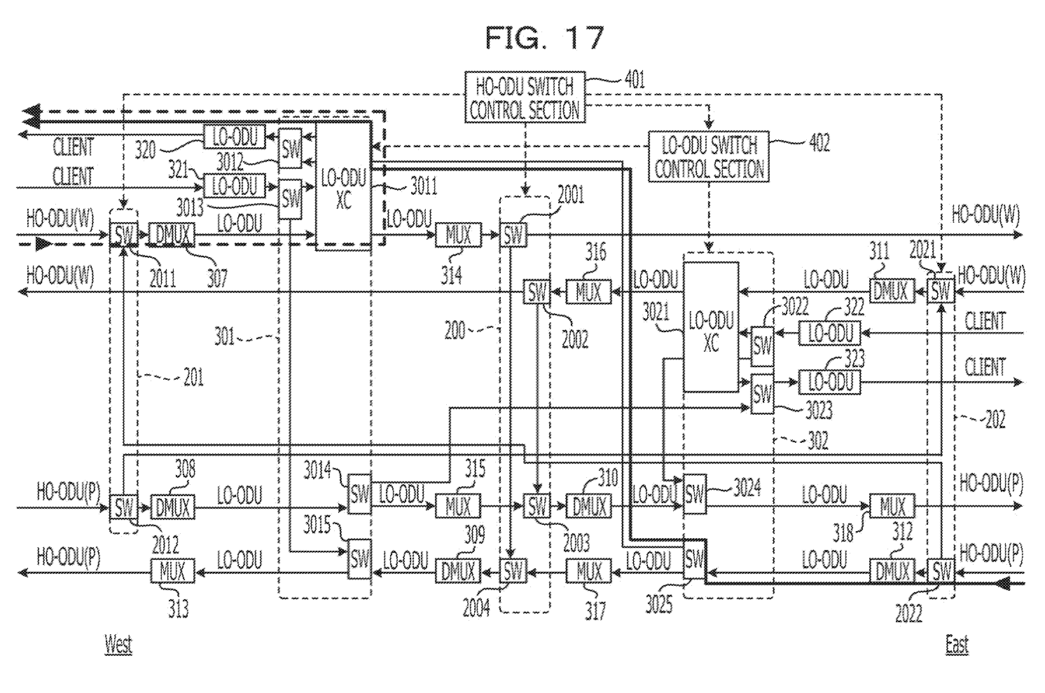

A receiving end switching processing operation will be described with reference to FIG. 17. In FIG. 17, regarding the client signal output to the west side, the case where a direction in which the client signal is received from the west side through the actually used line is selected is indicated using a bold dotted line, and the case where a direction in which the client signal is received from the east side through the backup line is selected is indicated using a bold solid line.

(E-1) Case where Direction in which Client Signal is Received from West Side through Actually Used Line is Selected

As indicated by the bold dotted line in FIG. 17, the HO-ODU (W) transmitted from the west side through the actually used line is channeled through the switch 2011 to the demultiplexer 307. The demultiplexer 307 separates the LO-ODU that is a reception object. The separated LO-ODU that is a reception object is channeled through the cross connect section 3011 and the switch 3012 to the LO-ODU processing section 320. The LO-ODU processing section 320 extracts the client signal from the payload of the LO-ODU supplied from the switch 3012.

(E-2) Case where Direction in which Client Signal is Received from East Side through Backup Line is Selected

As indicated by the bold solid line in FIG. 17, the HO-ODU (P) transmitted from the east side through the backup line is channeled through the switch 2022 to the demultiplexer 312. The demultiplexer 312 separates the LO-ODU that is a reception object. The separated LO-ODU that is a reception object is channeled by the switch 3025 through the cross connect section 3011 and the switch 3012 to the LO-ODU processing section 320. The LO-ODU processing section 320 extracts the client signal from the payload of the LO-ODU supplied from the switch 3012.

(F) Receiving End Switching Processing Operation Relating to Client Signal Output to West Side

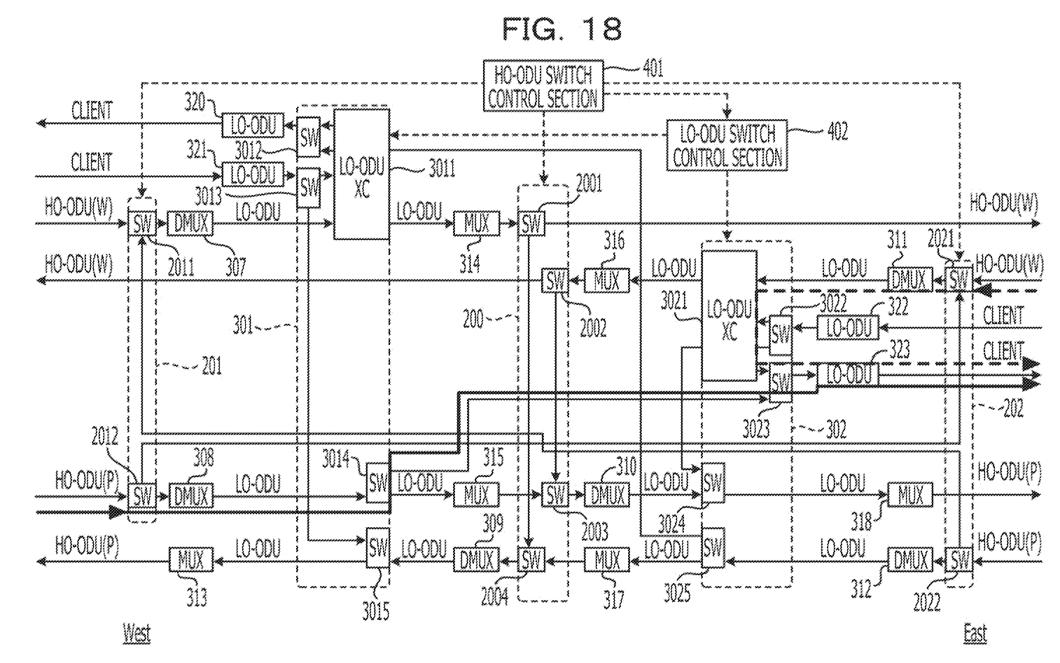

A receiving end switching processing operation will be described with reference to FIG. 18. In FIG. 18, regarding the client signal output to the west side, the case where a direction in which the client signal is received from the east side through the actually used line is selected is indicated using a bold dotted line, and the case where a direction in which the client signal is received from the west side through the backup line is selected is indicated using a bold solid line.

(F-1) Case where Direction in which Client Signal is Received from East Side through Actually Used Line is Selected

As indicated by the bold dotted line in FIG. 18, the HO-ODU (W) transmitted from the east side through the actually used line is channeled through the switch 2021 to the demultiplexer 311. The demultiplexer 311 separates the LO-ODU that is a reception object. The separated LO-ODU that is a reception object is channeled through the cross connect section 3021 and the switch 3023 to the LO-ODU processing section 323. The LO-ODU processing section 323 extracts the client signal from the payload of the LO-ODU supplied from the switch 3023.

(F-2) Case where Direction in which Client Signal is Received from West Side through Backup Line is Selected

As indicated by the bold solid line in FIG. 18, the HO-ODU (P) transmitted from the west side through the backup line is channeled through the switch 2012 to the demultiplexer 308. The demultiplexer 308 separates the LO-ODU that is a reception object. The separated LO-ODU that is a reception object is channeled through the switch 3014 and the switch 3023 to the LO-ODU processing section 323. The LO-ODU processing section 323 extracts the client signal from the payload of the LO-ODU supplied from the switch 3023.

The third embodiment will be described hereinafter. In the third embodiment, a specific example of a processing method performed, using an ODU overhead, between nodes during a period from when a failure occurs in the transmission path in the network to when the transmitting/receiving end switching processing operation is performed. In the embodiment, a transmitting/receiving end does not acquire failure point information but only a failure notification described later. Accordingly, when the processing method is applied to the first embodiment, it is desirable to replace the operation, performed in Step 14 in FIG. 9, with “failure notification is received”.

(3-1) Method in which Failure End Gives Notice of Occurrence of Failure

First, an example of a method in which a failure end notifies the transmitting/receiving end of the LO-ODU of the occurrence of a failure (referred to as “failure notification”) when the failure occurs in the transmission path in the network will be described. The failure notification (first information) is performed using STAT (referred to as “PM_STAT” hereinafter) that has three bits and is contained in the PM field of an LO-ODU overhead. The failure end changes the PM_STAT of the LO-ODU that is a transfer object to a specified code, for example, “100”, in order to preliminarily perform the failure notification. In addition, for the transmitting/receiving end, receiving of the LO-ODU, into the PM_STAT of which the specified code is written, from the failure end is a trigger for starting the transmitting/receiving end switching processing operation.

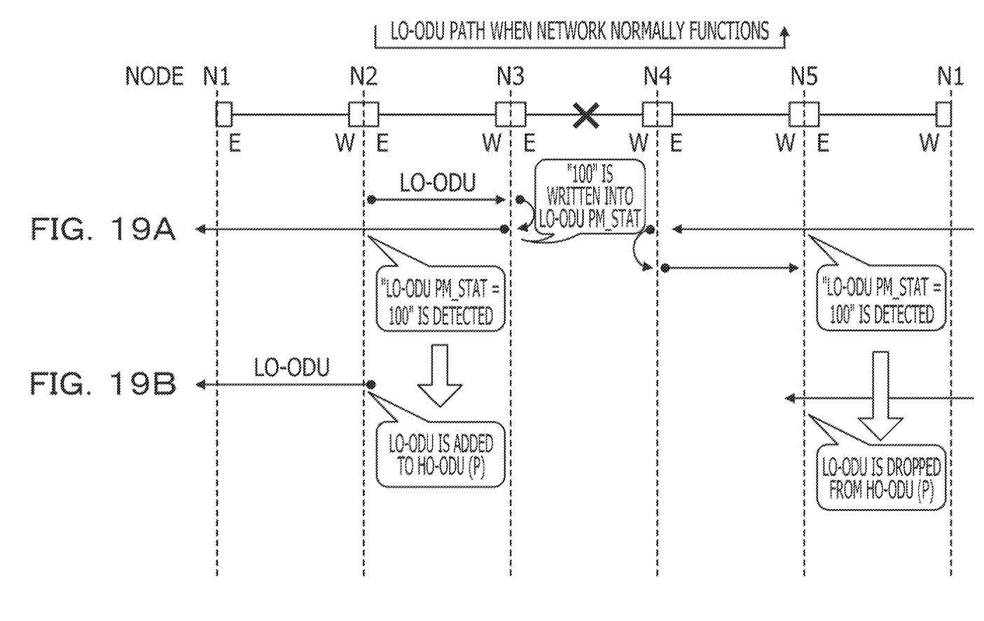

An example of the failure notification method will be described with reference to FIGS. 19A and 19B, hereinafter. FIGS. 19A and 19B are diagrams illustrating an example of the failure notification method performed in the network that includes six nodes N1 to N6, for example. In the example illustrated in FIGS. 19A and 19B, the transmitting end is the node N2, the receiving end is the node N5, and the path through which the LO-ODU is normally transmitted is a path that leads through the nodes N2→N3→N4→N5. At this time, it may be assumed that a failure occurs in a transmission path between the node N3 and the node N4. In FIGS. 19A and 19B, FIG. 19A illustrates a behavior in which the failure notification is performed in the network after the failure has occurred, and FIG. 19B illustrates the transmission behavior of the LO-ODU after the transmission direction or the reception direction of the LO-ODU has been switched at the transmitting/receiving end in response to the received failure notification.

Referring to FIG. 19A, the LO-ODU transmitted from the node N2 is mapped to the HO-ODU, and is transmitted to the node N3. In the node N3 that is the failure end, the PM_STAT of the LO-ODU overhead transferred from the node N2 is changed to “100”. In the node N3, the HO-ODU that includes the LO-ODU is returned to the backup line, and is transferred to the node N2. In the node N2, the PM_STAT in the overhead of the LO-ODU that is contained in the HO-ODU and transmitted through the backup line is recognized, and thereby the failure notification turns out to be performed for the node N2. The HO-ODU is further transferred through the backup line through the nodes N2→N1→N5→N4 in this order. The HO-ODU is returned again to the actually used line at the node N4 that is the failure end. In the node N5, the LO-ODU, into the PM_STAT of which “100” is written, is received, and thereby the failure notification turns out to be performed for the node N5. As mentioned above, when a failure occurs in the transmission path in the network, the failure notification is performed for the transmitting/receiving end by the failure end.

(3-2) Path Optimization Processing Operation for LO-ODU

In the transmitting/receiving end switching processing operation mentioned above, a path optimization processing operation for the LO-ODU is a processing operation for determining whether or not the path of the LO-ODU is switched, before the transmission direction or the reception direction of the LO-ODU is switched. Using the processing operation described in (3-1), the transmitting/receiving end recognizes whether the failure notification is received from the west side or the east side. As a result, the transmitting/receiving end determines the transmission direction or the reception direction of the LO-ODU to be a transmission/reception object so that the LO-ODU is transmitted or received from a side opposite to another side from which the failure notification is received. In other words, when the transmitting/receiving end receives the failure notification, the transmitting/receiving end determines the transmission direction or the reception direction of the LO-ODU so that the LO-ODU is newly transmitted or received to or from a node that is adjacent to the node corresponding to the transmitting/receiving end and is located at an opposite position from another node that transmits the failure notification to the node corresponding to the transmitting/receiving end and.

For example, in the example illustrated in FIG. 19B, since the node N2 that is the transmitting end receives at the east side the failure notification from the node N3 that is the failure end, the node N2 determines that the LO-ODU that is a transmission object is to be sent out from the west side. Since the node N5 that is the receiving end receives at the west side the failure notification from the node N4 that is the failure end, the node N5 determines that the LO-ODU that is a reception object is to be received from the east side. As illustrated in FIG. 19B, these determinations are performed in order for the path of the new LO-ODU to circumvent the failure point. In addition, as described above, at this time, while the necessity of a path switching is only determined, an actual switching processing operation is not performed. Accordingly, when, after the reception of the failure notification, it is determined that the path switching is not necessary, namely, it is determined that it is not necessary to switch the transmission/reception direction, the processing operation described later is not performed.

(3-3) Message Exchange Relating to Path Switching

When the transmitting/receiving end determines the path switching, consensus on the path switching is obtained between the transmitting end and the receiving end, and messages are exchanged in order to synchronize the timing of the path switching (namely, the timing of the transmission direction switching or the reception direction switching). For example, the message exchange is performed using an APS/PCC field (4 bytes) in the LO-ODU overhead. At this time, since the backup line does not operate at the transmitting/receiving end, the message exchange is performed by transferring the LO-ODU used for the message exchange through the actually used line between the transmitting end and the receiving end.

When the message exchange relating to the path switching is terminated, the transmitting/receiving end executes, in units of LO-ODUs, the transmitting/receiving end switching processing operation described in the first embodiment and the second embodiment. In addition, when the node configuration described with reference to FIG. 12 is adopted, the LO-ODU overhead information processing operation, the information collection, and the switching determination, which relate to the processing operations described in (3-1), (3-2), and (3-3), turn out to be performed in the LO-ODU switch control section 402.

Next, a fourth embodiment will be described. In the fourth embodiment, a specific example of a processing method performed, using an ODU overhead, between nodes during a period from when a failure occurs in the transmission path in the network to when the transmitting/receiving end switching processing operation is performed. The embodiment is a specific example distinct from the example described in the third embodiment, and, in the same way as the first embodiment, the specific example is configured so that the transmitting/receiving end acquires the failure point information. A node according to the embodiment preliminarily collects topology information and the path information of the LO-ODU when the network normally functions. The topology information is information that indicates connection states between the nodes in the network. Here, a specific ID (referred to as “node ID” hereinafter) is assigned to each node in the network, and the topology information and the path information are expressed using the node ID.

(4-1) Acquisition of Topology Information

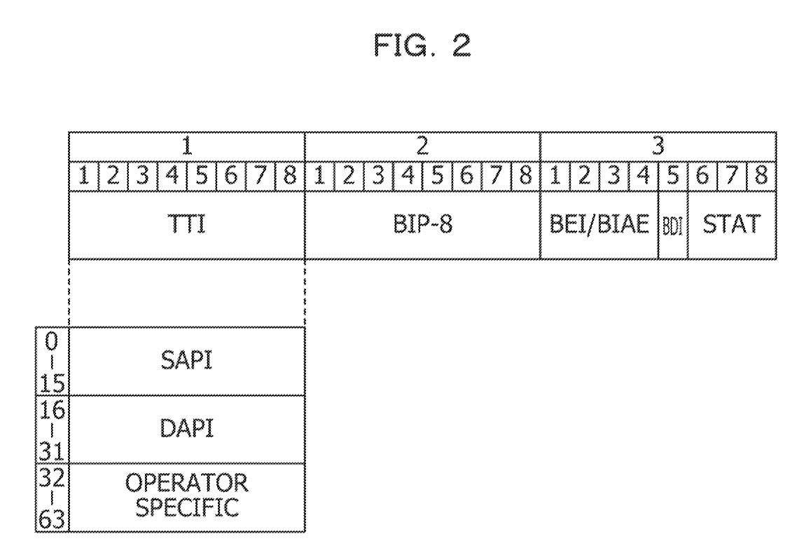

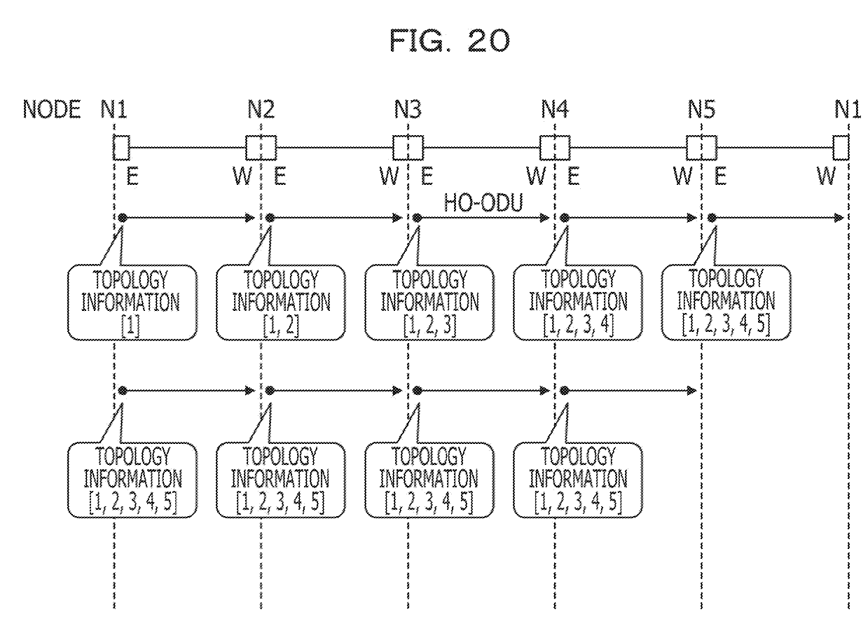

The topology information is acquired, for example, using a TTI (operator specific; refer to FIG. 2) in the PM field of the HO-ODU overhead. FIG. 20 is a diagram illustrating an example of an acquisition method for topology information, performed in the network that includes six nodes N1 to N5, for example. In the example illustrated in FIG. 20, it is assumed that the node IDs 1 to 5 are assigned to the nodes N1 to N5. In FIG. 20, the HO-ODU is transferred from the node N1 to the node N5 in order. In individual nodes, individual nodes ID are sequentially written into the TTI of the PM field (referred to as “PM_TTI” hereinafter) in such a way as [1]→[1, 2]→•••, as illustrated in FIG. 20. A list of node IDs written into the PM_TTI is expressed as a topology list. The topology list is held in each node.

Each node checks the topology list written into the PM_TTI of the HO-ODU transferred from the west side. In addition, each node additionally writes a node ID corresponding to the node into the topology list in the PM_TTI and transfers the topology list to another node at the east side, in a condition that the topology list in the PM_TTI is longer than a topology list held in the node and the node ID corresponding to the node has not been written into the topology list in the PM_TTI. As a result, the topology information is obtained from the topology list at the time when the HO-ODU has been transmitted around the ring network. In the example illustrated in FIG. 20, after the node N4 has received the topology list for the second time, the topology list does not become longer. Accordingly, it is determined that a final topology list has been completed. Namely, in the example, the topology list such as [1, 2, 3, 4, 5] turns out to be obtained as topology information.

In addition, the PM_TTI (operator specific) has 32 bytes. Therefore, when one byte is assigned to one node ID, topology information corresponding to 32 nodes can be transmitted. When node IDs are assigned to 32 or more than nodes, it is only necessary to increase the number of the bytes of the TTI using the setting of a multi frame alignment signal (MFAS) (the number can be increased up to 256 bytes). In addition, an acquisition method for the topology information is not limited to the method mentioned above. A method in which a topology list is written into a reserved for future international standardization (RES) field and is transferred, or a method in which topology information that has been acquired by a provisioning processing operation is used can be adopted.

(4-2) Acquisition of Path Information for LO-ODU

It is only necessary for each node in the network to acquire path information only relating to the path of the LO-ODU that the node transmits and receives (adds/drops). In order to acquire this path information, for example, a TTI (operator specific) in the PM field (referred to as “PM_TTI”) of the LO-ODU overhead that is a transmission/reception object can be used. In this case, in the same way as the method for acquiring the topology information, the LO-ODU is transferred between the transmitting/receiving ends, and, in each node in the path, the path information is written into the PM_TTI in the LO-ODU. Accordingly, the path information is acquired.

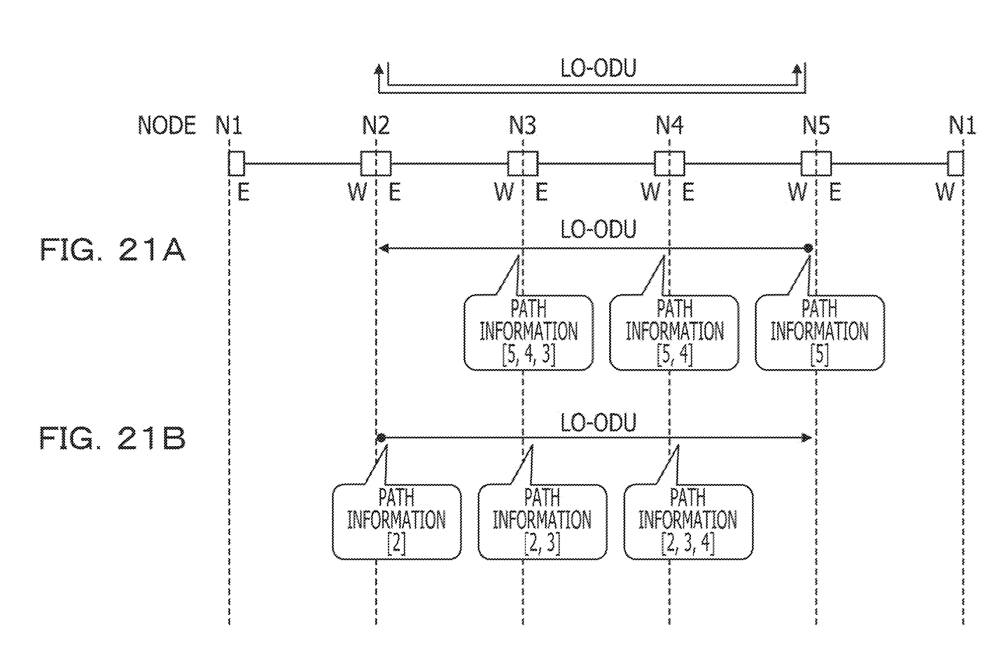

An example of the method for acquiring the path information of the LO-ODU will be described with reference to FIGS. 21A and 21B. In FIGS. 21A and 21B, the node N2 and the node N5 are the transmitting/receiving ends. As illustrated in FIG. 21A, when the LO-ODU is transferred from the node N5 to the node N2, the path information is sequentially written into the PM_TTI of the LO-ODU in such a way as [5]→[5, 4]→[5, 4, 3]→•••, in response to the transfer of the LO-ODU. On the other hand, as illustrated in FIG. 21B, when the LO-ODU is transferred from the node N2 to the node N5, the path information is sequentially written into the PM_TTI of the LO-ODU in such a way as [2]→[2, 3]→[2, 3, 4]→•••, in response to the transfer of the LO-ODU.

In the example, only in the receiving end, final path information turns out to be obtained. However, usually in the OTN, two ODUs to be transmitted in two directions opposite to each other are configured as one unit, and information that indicates which ODUs are united is preliminarily assigned to each node. Accordingly, if, regarding the LO-ODU transmitted in a direction, node IDs in the path information obtained at the receiving end are traced back, the path information of the LO-ODU transmitted in an opposite direction can be obtained. For example, in FIG. 21A, in the node N2, path information [5, 4, 3, 2] is obtained as the path information of the LO-ODU transmitted from the node N5 to the node N2. Therefore, in the node N2, by tracing back the node IDs in the path information [5, 4, 3, 2], path information [2, 3, 4, 5] turns out to be obtained as the path information of the LO-ODU transmitted from the node N2 to the node N5.

(4-3) Acquisition of Failure Point Information

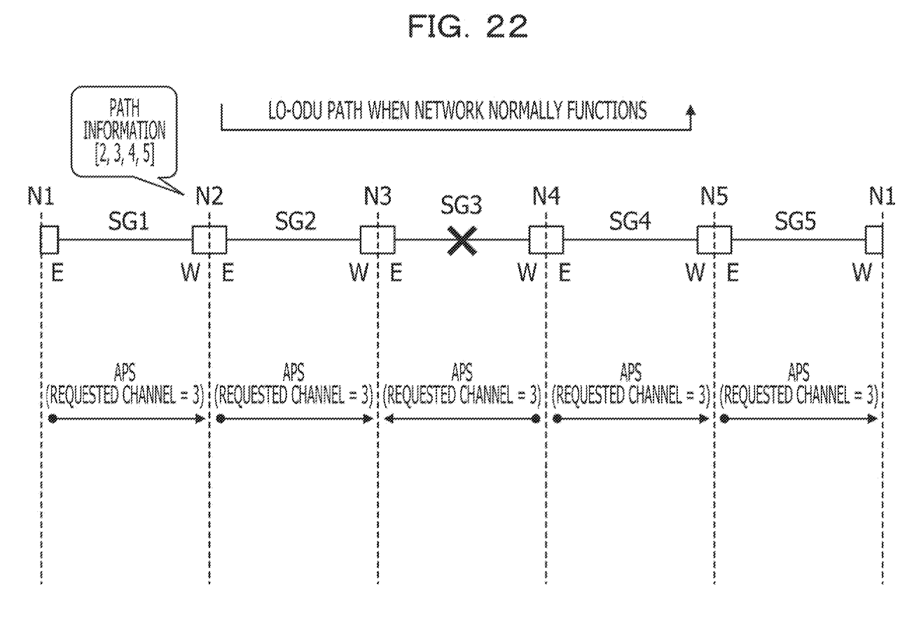

In the embodiment, the notification of failure point information to each node is performed using an APS/PCC field in the HO-ODU overhead. The notification method will be described with reference to FIG. 22. In the notification method, for example, a segment between a node and another node adjacent to the node at the east side thereof is preliminarily set to the value of the node ID of the node. In the example illustrated in FIG. 22, a segment at the east side of the node N1 is set to segment SG1, a segment at the east side of the node N2 is set to segment SG2, •••. Here, it may be assumed that when the network normally functions, the LO-ODU is transmitted from the node N2 and the node N5, and, after that, a failure occurs in a transmission path between the node N3 and the node N4. In this case, for example, the node N4 that is the receiving end of the LO-ODU detects a failure in the segment SG3. In addition, the node N4 writes a predetermined code corresponding to the segment SG3 into the APS/PCC field in the HO-ODU (in FIG. 22, for example, a predetermined requested channel in the field), and transfers the HO-ODU in two directions in the network. Since each node has known a correspondence relationship relating to which internode the segment corresponds to, each node can acquire the failure point information by reading out the APS/PCC field in the transferred HO-ODU.

After the transmitting/receiving end has acquired the failure point information, the transmitting/receiving end performs individual processing operations such as the path optimization processing operation for the LO-ODU and the message exchange processing operation relating to the path switching, or the like. The same methods as those described in (3-2) and (3-3) in the third embodiment can be adopted for the individual processing operations, respectively. After the message exchange processing operation relating to the path switching has been terminated, the transmitting/receiving end executes the transmitting/receiving end switching processing operation in units of LO-ODUs.

In addition, if the node configuration described with reference to FIG. 12 is adopted, the acquisition of the topology information and the acquisition of the failure point information are performed in the HO-ODU switch control section 401. In addition, the acquisition of the path information of the LO-ODU is performed in the LO-ODU switch control section 402. At this time, the topology information and the failure point information are provided from the HO-ODU switch control section 401 to the LO-ODU switch control section 402. In addition, on the basis of the topology information, the failure point information, and the path information of the LO-ODU, the LO-ODU switch control section 402 performs the path optimization processing for the LO-ODU.

In addition, while, in the embodiment, the case in which, using the ODU overhead, each node acquires the topology information and the path information is illustrated, an acquisition method is not limited to the case. When a network management system (NMS) manages the network in an integrated fashion, the NMS may acquire the topology information, the path information, and the failure point information in an integrated fashion, and thereby determine whether or not each node performs the failure end switching processing operation and the transmitting/receiving end switching processing operation. In this case, in units of the HO-ODUs or the LO-ODUs, the NMS instructs each node to perform the switching processing operations.

While embodiments of the present invention are described in detail as above, the signal transmission method and the transmission device (node) according to the present invention are not limited to the embodiments described above. In addition, it should be understood that the various modifications and various changes could be made hereto without departing from the spirit and scope of the present invention. For example, while, in the embodiment, the case in which the LO-ODU is applied to the first signal in the first layer, and the HO-ODU is applied to the second signal in the second layer, the signal transmission method and the transmission device according to the present invention are not limited to the case. If a signal to be processed in the network is specified in two layers, the first signal that is a transmission/reception object and is in an upper layer is contained in the second signal that is in a lower layer, and transmission between nodes is performed using the second signal, the types of individual signals and the levels of hierarchy or the like are not considered.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Although the embodiment(s) of the present invention(s) has(have) been described in detail, it should be understood that the various changes, substitutions, and alterations could be made hereto without departing from the spirit and scope of the invention.

1. A signal transmission method of transmitting a signal in a network including a plurality of nodes connected in a ring shape, the signal is capable of being transmitted from individual nodes in first and second directions toward adjacent nodes, and an actually used line and a backup line are provided in each of the transmission directions, the signal transmission method comprising:
when no failure occurs in a transmission path, causing each of the plurality of nodes to transfer, using the actually used line, a second signal in a second layer, in which one or a plurality of first signals in a first layer are contained, to a node adjacent in the first or the second direction when each of the plurality of nodes transmits or receives the first signal; and
when a failure occurs in the transmission path in the network, causing a first node, located at an end of a failure point, to switch a transmission direction of the second signal and to send out the second signal to the backup line, and causing a second node, which is a transmission source or a reception destination of the first signal, to select one of the first and second directions as a transmission direction or a reception direction of the first signal so that a path for the first signal circumvents the failure point.

2. The signal transmission method according to claim 1, wherein
the one of the first and second directions is selected by the second node,
a transmission direction or a reception direction of the second signal in which the first signal is contained is switched to an opposite direction when there is the failure point in a path for the first signal that is to be a transmission or reception object when no failure is assumed to occur in the transmission path in the network; and
the transmission direction or the reception direction of the second signal in which the first signal is contained is not switched to the opposite direction when there is no failure point in the path.

3. The signal transmission method according to claim 2, further comprising:
causing the first signal, the transmission direction or reception direction of which is to be a switching object, to be contained in the second signal and to be sent out through the backup line, or to be extracted from the second signal received through the backup line.

4. The signal transmission method according to claim 1, further comprising:
causing the first node to add first information, which indicates that a failure occurs, to the first signal, which is to be a transmission object or a reception object for the second node, and to transmit the first signal to the second node,
wherein
the one of the first and second directions is selected by the second node,
when the second node receives the first signal to which the first information is added, the second node transmits the first signal to a node, which is adjacent to the second node and is located at an opposite position from another node that is adjacent to the second node and transmits the received first signal to the second node, or receives the first signal from the node that is located at the opposite position.

5. The signal transmission method according to claim 4, further comprising:
causing the first node to write a specified code as the first information into an overhead in the first signal; and
causing the second node to recognize the specified code from the overhead in the first signal transferred through the network.

6. The signal transmission method according to claim 1, further comprising:
causing nodes in the network to share topology information that indicates connection states between nodes in the network;
causing the second node, which is to be a transmission source or a reception destination of the first signal, to acquire path information relating to a path through which the first signal, which is to be a transmission object or a reception object, is transmitted in the network; and
causing the second node to acquire failure point information, used for specifying the failure point, from the first node when a failure occurs in the transmission path in the network.

7. The signal transmission method according to claim 6, wherein,
in the topology information sharing,
the second signal is sequentially transferred between the nodes in the network, and individual nodes sequentially write specific identifiers, preliminarily assigned to the individual nodes, into an overhead in the transferred second signal, and the individual nodes share the topology information.

8. The signal transmission method according to claim 6, wherein,
in the path information acquiring,
individual nodes sequentially write specific identifiers, preliminarily assigned to the individual nodes, into an overhead in the first signal, and the second node acquires the path information, the individual nodes being in a path through which the first signal, which is to be a transmission object or a reception object, is transmitted in the network.

9. The signal transmission method according to claim 6, wherein,
in the failure point information acquiring,
the first node, located at an end of the failure point, write an identifier, which is preliminarily assigned to the first node and is related to a transmission path between nodes, into an overhead in the second signal, and causes the second signal to be sequentially transferred between the nodes in the network, and the second node acquires the failure point information.

10. The signal transmission method according to claim 1, further comprising:
synchronizing, using an overhead in the first signal, the switching between the first node and the second node that is a transmission source and a reception destination when the transmission direction or the reception direction of the first signal is switched to an opposite direction.

11. A transmission device for transmitting a signal in a network including a plurality of transmission devices connected in a ring shape, the signal is capable of being transmitted from individual transmission devices in first and second directions toward adjacent transmission devices, and an actually used line and a backup line are provided in each of the transmission directions, the transmission device comprising:
a transmission and reception section to transfer, using the actually used line, a second signal in a second layer, in which one or a plurality of first signals in a first layer are contained, to a transmission device adjacent in the first or the second direction when the first signal is transmitted or received, when no failure occurs in a transmission path in the network;
a first processing section to switch a transmission direction of the second signal and send out the second signal to the backup line, when a failure occurs in the transmission path in the network and the transmission device is located at an end of a failure point; and
a second processing section to select one of the first and second directions as a transmission direction or a reception direction of the first signal so that a path for the first signal circumvents the failure point, when the failure occurs and the transmission device is a transmission source or a reception destination of the first signal.

12. The transmission device according to claim 11, wherein,
the second processing section switches a transmission direction or a reception direction of the second signal in which the first signal is contained to an opposite direction when there is the failure point in a path for the first signal that is to be a transmission or reception object in a case in which no failure is assumed to occur in the transmission path in the network; and
the second processing section does not switch the transmission direction or the reception direction of the second signal when the first signal is contained to the opposite direction when there is no failure point in the path.

13. The transmission device according to claim 12, wherein,
the transmission and reception section causes the first signal, the transmission direction or reception direction of which is to be a switching object, to be contained in the second signal and to be send out through the backup line, or to be extracted from the second signal received through the backup line.

14. The transmission device according to claim 11, wherein,
in the case in which one of the first and second directions is determined,
when the first signal that is a transmission object or a reception object and to which first information, which indicates that a failure occurs, is added is received, the transmission device transmits the first signal to a second transmission device, which is adjacent to the transmission device and is located at an opposite position from a third transmission device that is adjacent to the transmission device and transmits the received first signal to the transmission device, or receives the first signal from the second transmission device that is located at the opposite position.

15. The transmission device according to claim 14, wherein,
a specified code is written as the first information into an overhead in the first signal, and
recognizing, by reading out the specified code, that a failure has occurred.

16. The transmission device according to claim 11, wherein,
topology information that indicates connection states between transmission devices in the network and path information relating to a path through which the first signal, which is to be a transmission object or a reception object, is transmitted in the network are held, and
when a failure occurs in the transmission path in the network, failure point information, used for specifying the failure point, is acquired from another transmission device located at an end of the failure point.

17. The transmission device according to claim 11, wherein,
when the transmission direction or the reception direction of the first signal is switched to an opposite direction, the switching between the transmission device and another transmission device that is a receiver or a transmitter is synchronized using the overhead in the first signal.
